(19) United States
(12) Patent Application Publication
(10) Pub. No.: US 2025/0327996 A1
(43) Pub. Date: Oct. 23, 2025

(54) OPTICAL SYSTEM AND CAMERA MODULE COMPRISING SAME

(71) Applicant: LG INNOTEK CO., LTD., Seoul (KR)

(72) Inventor: Doo Shik SIN, Seoul (KR)

(73) Assignee: LG INNOTEK CO., LTD., Seoul (KR)

(21) Appl. No.: 18/867,403

(22) PCT Filed: May 22, 2023
(86) PCT No.: PCT/KR2023/006948

§ 371 Date: Nov. 19, 2024

(30) Foreign Application Priority Data
May 20, 2022 (KR) 10-2022-0062219

(51) Int. Cl. G02B 13/00; G02B 9/64

(52) U.S. Cl. CPC G02B 13/0045; G02B 9/64

(57) ABSTRACT

The optical system disclosed in the embodiment of the invention includes first to ninth lenses disposed along an optical axis in a direction from an object side to a sensor side, wherein the first lens and the third lens have different refractive powers on the optical axis, the first to third lenses have a meniscus shape convex toward the object side on the optical axis, an object-side surfaces of each of the eighth lens and the ninth lens have a convex shape on the optical axis, and the following Equations may satisfy: 0.5<ΣCT/ΣCG<3 and 0<CT_Max/CG_Max<2 (ΣCT is a sum of a center thicknesses of the first to ninth lenses, ΣCG is a sum of optical axis distances between the first to ninth lenses, CT_Max is a maximum of the center thicknesses of each lens, and CG_Max is a maximum of the optical axis distances).

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, distance, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. An embodiment provides an optical system having excellent optical performance at the center and periphery portions of the field of view. An embodiment provides an optical system capable of having a slim structure.

### Technical Solution

An optical system according to an embodiment of the invention comprises first to ninth lenses disposed along an optical axis in a direction from an object side to a sensor side, wherein the first lens and the third lens have different refractive powers on the optical axis, the first to third lenses have a meniscus shape convex toward the object side on the optical axis, an object-side surfaces of each of the eighth lens and the ninth lens have a convex shape on the optical axis, and the following Equations may satisfy: 0.5<ΣCT/ΣCG<3 and 0<CT_Max/CG_Max<2 (ΣCT is a sum of a center thicknesses of the first to ninth lenses, ΣCG is a sum of optical axis distances between the first to ninth lenses, CT_Max is a maximum of center thicknesses of each lens, and CG_Max is a maximum of the optical axis distances).

According to an embodiment of the invention, the object-side surface of the eighth lens has a first critical point, and a sensor-side surface of the eighth lens has a second critical point, and the second critical point may be disposed further outside than the first critical point with respect to the optical axis.

According to an embodiment of the invention, the first critical point is disposed in a range of 32% to 52% of a distance from the optical axis of the object-side surface of the eighth lens to an end of an effective region, and the second critical point may be disposed in a range of 14% to 34% of a distance from the optical axis of a sensor-side surface of the ninth lens to an end of an effective region.

According to an embodiment of the invention, a maximum angle of a tangent line passing through the sensor-side surface of the eighth lens may be greater than a maximum angle of a tangent line passing through the sensor-side surface of the ninth lens.

According to an embodiment of the invention, each of the eighth lens and the ninth lens may have a meniscus shape convex toward the object side on the optical axis.

According to an embodiment of the invention, an optical axis distance (CG8) between the eighth lens and the ninth lens and a minimum distance (G8_Min) between the eighth lens and the ninth lens may satisfy the following Equation: 1<CG8/G8_min<10.

According to an embodiment of the invention, an optical distance (CG8) between a curvature radius (L8R2) of a sensor-side surface of the eighth lens and a curvature radius (L9R1) of the object-side surface of the ninth lens and a minimum distance (G8_Min) between the eighth lens and the ninth lens may satisfy the following Equation: of 0<L8R2/L9R1<5.

According to an embodiment of the invention, a sensor-side surface of the third lens has a concave shape on the optical axis, the object-side surface of the fourth lens has a convex shape on the optical axis, and a center distance (CG3) and an edge distance (EG3) between the third and fourth lenses may satisfy the following Equation: 2<CG3/EG3<20.

According to an embodiment of the invention, the focal lengths (F3, F6, F7, and F9) of the third, sixth, seventh, and ninth lenses satisfy: F3<0, F6<0, F7<0, and F9<0, and a composite focal length F13 of the first to third lenses may satisfy: F13>0, and a composite focal length F49 of the fourth lens and the ninth lens may satisfy: F49<0.

According to an embodiment of the invention, refractive indices n3, n5, and n6 of the third, fifth, and sixth lenses at the d-line may satisfy: 1.6<n3, 1.6<n5, and 1.6<n6.

An optical system according to an embodiment of the invention includes a first lens group having three or less lenses on an object side; and a second lens group having a plurality of lenses on a sensor side of the first lens group, wherein the first lens group has a positive (+) refractive power on the optical axis, the second lens group has a negative (−) refractive power on the optical axis, a number of lenses of the second lens group is greater than that of the first lens group, and at least one of lens surfaces facing a region between the first lens group and the second lens group has the smallest effective diameter, a sensor-side surface closest to an image sensor among the lens surfaces of the second lens group has the largest effective diameter, and each of lenses of the first lens group has a meniscus shape that is convex toward the object side on the optical axis, and the following Equations may satisfy: 0.5<TTL/ImgH<3 and 0.01<BFL/ImgH<0.5 (TTL is a distance from an apex of an object-side surface of the first lens group to an image surface of the image sensor, ImgH is ½ of the maximum diagonal length of the image sensor, and BFL is an optical axis distance from the image sensor to a sensor-side surface closest to the image sensor.).

According to an embodiment of the invention, when a focal length of each of the first and second lens groups is expressed as an absolute value, the focal length of the first lens group may be smaller than the focal length of the second lens group.

According to an embodiment of the invention, the first lens group includes first to third lenses aligned on an optical axis toward the sensor from the object side, and the second lens group includes fourth to ninth lenses aligned from the first lens group toward the object side, and the following Equations may satisfy: 0.5<CA_L1S1/CA_min<2 and 1<CA_max/CA_min<5 (CA_L1S1 is an effective diameter of an object-side surface of the first lens, and CA_Min is a minimum of the effective diameters of the object-side and the sensor-side surfaces of the first to ninth lenses, and CA_Max means a maximum of the effective diameters of the object-side and sensor-side surfaces of the first to ninth lenses).

According to an embodiment of the invention, both the object-side surface and the sensor-side surface of the eighth lens may have a critical point, and both the object-side surface and the sensor-side surface of the ninth lens may have a critical point.

According to an embodiment of the invention, a maximum of a distance between the eighth and ninth lenses is a maximum of distances between the first to ninth lenses, and a maximum thickness of the ninth lenses may be a maximum among the thicknesses from the optical axis of the first to ninth lenses to an end of an effective region.

According to an embodiment of the invention, the center thickness of each lens and the center distance between adjacent lenses may satisfy the following Equation: 0.5<CT/ΣCG<3 (ΣCT is a sum of the thicknesses of the first to ninth lenses in the optical axis, and ΣCG is a sum of distances between the first to ninth lenses in the optical axis).

According to an embodiment of the invention, the following Equation may satisfy: 0.1<CA_max/(2*ImgH)<1 (CA_max means a largest effective diameter among object-side surface and sensor-side surfaces of each lens)

According to an embodiment of the invention, a composite focal length (F13) and effective focal length (F) of the first lens group and a composite focal length (F49) of the second lens group may satisfy the following Equations: 0<F13/F<5 and 1<|F49|/F13<15.

A camera module according to an embodiment of the invention includes an image sensor; and a filter between the image sensor and a last lens of an optical system, wherein the optical system includes a optical system disclosed above, and may satisfy the following Equation: 1≤F/EPD<5 and FOV<120 (F is a total focal length of the optical system, EPD is an entrance pupil diameter of the optical system, and FOV is a field of view).

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the field of view (FOV). The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system according to a first embodiment.

FIG. 2 is an explanatory diagram illustrating a relationship among an image sensor, an n-th lens, and an n−1th lens in the optical system of FIG. 1.

FIG. 3 is a table showing lens characteristics of the optical system of FIG. 1.

FIG. 4 is a table showing aspheric coefficients of an object-side surface and a sensor-side surface of a lens of the optical system of FIG. 1.

FIG. 5 is a table showing lens thicknesses and distances between adjacent lenses in a first direction Y orthogonal to the optical axis from an optical axis in the optical system of FIG. 1.

FIG. 6 is a table showing Sag values of the object-side surface and the sensor-side surface of the n-th lens, the n−1th lens, and the n−2-th lens in the optical system of FIG. 1.

FIG. 7 is a graph of diffraction MTF of the optical system of FIG. 1.

FIG. 8 is a graph showing aberration characteristics of the optical system of FIG. 1.

FIG. 9 is a graph showing heights in the optical axis direction according to distances in the first direction Y with respect to the object-side surface and the sensor-side surface in the n-th lens and the n−1th lens of the optical system of FIG. 2.

FIG. 10 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

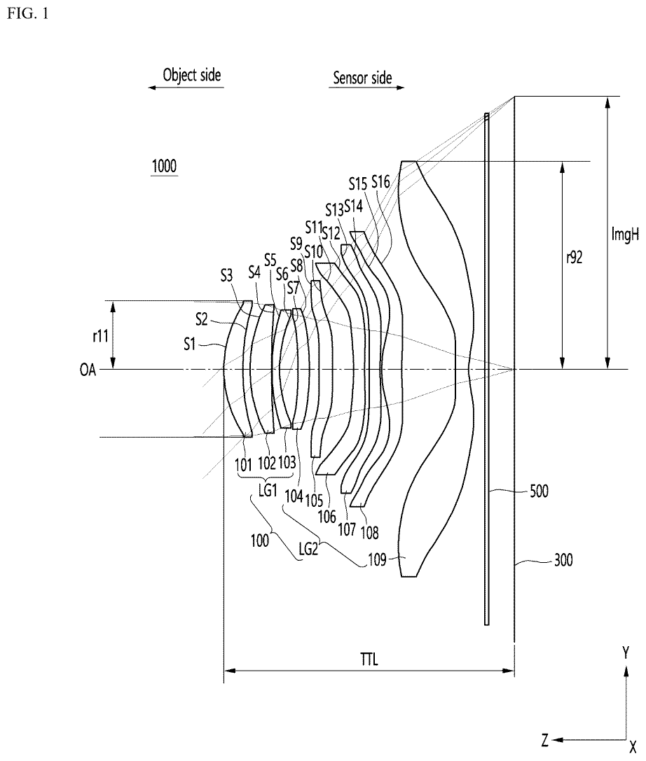

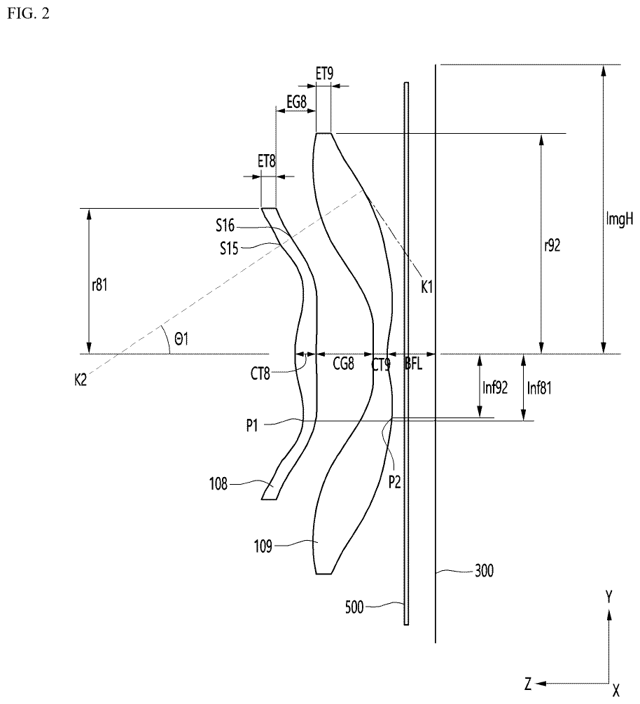

As shown in FIGS. 1 and 2, the optical system 1000 according to an embodiment of the invention may include a plurality of lens groups. In detail, each of the plurality of lens groups includes at least one lens. For example, the optical system 1000 may include a first lens group LG1 and a second lens group LG2 sequentially disposed along the optical axis OA toward the image sensor 300 from the object side. Here, the first lens group LG1 is located on the object side and refracts some incident light in the optical axis direction, and the second lens group LG2 may refract some light emitted through the first lens group LG1 so as to spread to the periphery portion of the image sensor 300.

The first lens group LG1 may include at least one lens. The first lens group LG1 may include four or less lenses. For example, the first lens group LG1 may include three lenses. The second lens group LG2 may include at least two or more lenses, and may include 1.5 times more lenses than the lenses of the first lens group LG1. The second lens group LG2 may include seven or less lenses. The number of lenses of the second lens group LG2 may have a difference of three or more and four or less compared to the number of lenses of the first lens group LG1. For example, the second lens group LG2 may include six lenses.

Object-side surfaces and sensor-side surfaces of all lenses of the first lens group LG1 may be provided without critical points. In the optical system 1000, at least one or both of the object-side surface and the sensor-side surface of the nth and n−1th lenses may have at least one critical point. Here, n is a lens closest to the image sensor 300 in the optical system 1000 and may range from 8 to 10, preferably 9. The sensor-side surface of the n-th lens may have a critical point, for example, the critical point P2 of the sensor-side surface of the n-th lens may be located 34% or less of the effective radius with respect to the optical axis OA, for example, in a range of 14% to 34% or in a range of 19% to 29%.

The object-side surface of the n-th lens may have a critical point within an end of the effective region from the optical axis OA, and the critical point may be located closer to the optical axis OA than the critical point P2 of the sensor-side surface. The critical point of the object-side surface of the n-th lens may be located within 18% or less of the distance from the optical axis OA to the end of the effective region, for example, in the range of 5% to 18% or in the range of 5% to 13%.

At least one or both of the object-side surface and the sensor-side surface of the n−1th lens may have a critical point. For example, the critical point of the object-side surface of the n−1th lens may be located at least 32% of the effective radius with respect to the optical axis OA, for example, in the range of 32% to 52%, or in the range of 37% to 47%, and the critical point of the sensor-side surface may be located in 39% or less of the effective radius based on the optical axis OA, for example, in the range of 19% to 39% or in the range of 24% to 34%. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface decreases as it increases, or a point where the slope value increases as it decreases.

The first lens group LG1 may have positive (+) refractive power. The second lens group LG2 may have negative (−) refractive power. The first lens group LG1 and the second lens group LG2 may have different focal lengths. Based on an absolute value, the focal length F_LG2 of the second lens group LG2 may be greater than the focal length F_LG1 of the first lens group LG1. For example, the focal length of the second lens group LG2 may be 1.1 times or more, for example, 1.1 times to 8 times the focal length F_LG1 of the first lens group LG1. The number of lenses having positive (+) refractive power in the optical system 1000 may be greater than the number of lenses having negative refractive power. In the first lens group LG1, the number of lenses having positive refractive power may exceed 50%, and the number of lenses having negative (−) refractive power may be less than 50%. That is, in the optical system, the number of lenses having negative (−) refractive power may be 4 or less, and the number of lenses having positive (+) refractive power may be at least 4 or more. Accordingly, the optical system 1000 according to the embodiment may improve chromatic aberration and distortion aberration by controlling the refractive power and focal length of each lens group, and may have good optical performance in the center and periphery portions of the FOV.

In the optical axis OA, the first lens group LG1 and the second lens group LG2 may have a set distance. A distance between the first lens group LG1 and the second lens group LG2 may be an optical axis distance between the sensor-side surface of the lens closest to the sensor side among the lenses in the first lens group LG1 and the object-side surface of the lens closest to the object side among the lenses in the second lens group LG2. A distance between the first lens group LG1 and the second lens group LG2 on the optical axis OA may be greatest at the center. The sensor-side surface of the lens closest to the sensor among the lenses in the first lens group LG1 has a concave shape on the optical axis OA, and the object-side surface of the lens closest to the object side among the lenses in the second lens group LG2 has a concave shape on the optical axis OA.

The optical axis distance between the first lens group LG1 and the second lens group LG2 may be greater than the center thickness of the last lens of the first lens group LG1 and the first lens of the second lens group LG2. The optical axis distance between the first and second lens groups LG1 and LG2 may be larger than the center thickness of the thinnest lens among the lenses of the first and second lens groups LG1 and LG2. An optical axis distance between the first lens group LG1 and the second lens group LG2 may be the third largest among distances between lenses. The largest optical axis distance in the optical system 1000 may be the optical axis distance between the n-th lens and the n−1th lens.

The optical axis distance between the first lens group LG1 and the second lens group LG2 may be less than 50% of the optical axis distance of the first lens group LG1, and may be less than 20% of the optical axis distance of the second lens group LG2. A maximum optical axis distance among the lenses may be greater than 50% of the optical axis distance of the first lens group LG1 and less than 50% of the optical axis distance of the second lens group LG2. Accordingly, the distance between the first and second lens groups LG1 and LG2 and the maximum optical axis distance may be set.

The optical axis distance of the first lens group LG1 may be smaller than the optical axis distance of the second lens group LG2. Here, the optical axis distance of the first lens group LG1 may be an optical axis distance between the object-side surface of the lens closest to the object side of the first lens group LG1 and the sensor-side surface of the lens closest to the sensor side.

The optical axis distance of the second lens group LG2 may be an optical axis distance between the object-side surface of the lens closest to the object side of the second lens group LG2 and the sensor-side surface of the lens closest to the sensor. The optical axis distance of the second lens group LG2 may be 2.1 times or more, for example, in the range of 2.1 times to 4.1 times or in the range of 2.6 times to 3.6 times the optical axis distance of the first lens group LG2. Accordingly, the optical system 1000 provides a long optical axis distance of the second lens group LG2, so that the incident light may be refracted to the periphery of the image sensor 300, good optical performance may be achieved not only in the center portion of the field of view (FOV) but also in the periphery portion, and chromatic aberration and distortion aberration may be improved.

The distance between the sensor-side surface of the first lens group LG1 and the object-side surface of the second lens group LG2 facing each other may gradually decrease toward the edge side of the optical axis OA. At this time, the center distance between the sensor-side surface of the first lens group LG1 and the object-side surface of the second lens group LG2 has a maximum, an edge distance is a minimum, and the maximum distance may differ from the minimum distance by 1.1 times or more, for example, in a range of 1.1 to 3.1 times. In the optical system 1000, the sum of lenses having a convex surface on the object side and a concave surface on the sensor side in the optical axis OA or paraxial region of each lens may be less than 50% of all lenses.

Each of the plurality of lenses 100 may include an effective region and a non-effective region. The effective region may be a region through which light incident on each of the lenses passes. That is, the effective region may be an effective region in which the incident light is refracted to implement optical properties, and may be represented by an effective diameter or an effective radius. The non-effective region may be arranged around the effective region. The non-effective region is a region in which effective light is not incident from the plurality of lenses, and may be a region further outside an end of the effective region. That is, the non-effective region may be a region unrelated to the optical characteristics. Also, an end of the non-effective region may be a region fixed to a barrel (not shown) accommodating the lens.

The optical system 1000 may include an image sensor 300. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS).

The optical system 1000 may include a filter 500. The filter 500 may be disposed between the second lens group LG2 and the image sensor 300. The filter 500 may be disposed between a lens closest to a sensor side among the plurality of lenses 100 and the image sensor 300. For example, when the optical system 100 is nine lenses, the filter 500 may be disposed between the n-th, that is, the ninth lens 109 and the image sensor 300.

The filter 500 may include at least one of an infrared filter and an optical filter of a cover glass. The filter 500 may pass light of a set wavelength band and filter light of a different wavelength band. When the filter 500 includes an infrared filter, radiant heat emitted from external light may be blocked from being transferred to the image sensor 300. In addition, the filter 500 may transmit visible light and reflect infrared light.

According to an embodiment of the invention, a TTL may be greater than 2 mm and less than 20 mm, for example, in the range of 4 mm to 12 mm, 4 mm to 10 mm, or 6 mm to 10 mm. The TTL may be in a range of 70% or more of ImgH, for example, in the range of 70% to 130% or in the range of 80% to 120%. Accordingly, the ratio of TTL/(ImgH*2) may be set to 60% or less, for example, in the range of 50% to 60%, so that a slim optical system may be provided. In addition, the FOV is provided in the range of less than 120 degrees, for example, 70 degrees or more to 119 degrees or 80 degrees to 100 degrees, so that an optical system having the FOV close to a wide angle or a wide angle may be designed. Here, the TTL is an optical axis distance from the object-side surface of the first lens group LG1 to the image sensor 300, and ImgH is the length from the center of the image sensor 300 to the diagonal end.

The maximum effective diameter Max_CA of a lens in the optical system 1000 may be greater than the TTL. The maximum effective diameter Max_CA of a lens in the optical system 1000 may be greater than ImgH. For example, the maximum effective diameter Max_CA may be in the range of 1.1<Max_CA/ImgH<2.1 or in the range of 1.3≤Max_CA/ImgH≤1.8. The maximum effective diameter Max_CA may be in the range of 1.01≤Max_CA/TTL<2 or in the range of 1.1≤Max_CA/TTL<1.8. Accordingly, by setting the maximum effective diameter Max_CA according to ½ of the maximum length of the image sensor 300, that is, ImgH and TTL, the incident light may be refracted to the periphery of the image sensor 300.

The optical system 1000 according to the embodiment may include an aperture stop (not shown). The aperture stop may control the amount of light incident to the optical system 1000. The aperture stop may be disposed at a set position, for example, disposed around an object-side surface or a sensor-side surface of any one lens of the first lens group LG1. The aperture stop may be positioned between two lenses closest to the object side. As another example, the aperture stop may be disposed around a sensor-side surface closest to the second lens group LG2 among the lenses of the first lens group LG1. As another example, the aperture stop may be disposed around the periphery between the first lens group LG1 and the second lens group LG2. Alternatively, at least one lens selected from among the plurality of lenses 100 may serve as an aperture stop. In detail, an object-side surface or a sensor-side surface of one lens selected from among the lenses of the first lens group LG1 may serve as an aperture stop for adjusting the amount of light. The optical system 1000 according to the embodiment may further include a reflective member (not shown) for changing a path of light on the object side of the first lens group LG1. The reflective member may be implemented as a prism that reflects incident light toward lenses. Hereinafter, an optical system according to an embodiment will be described in detail.

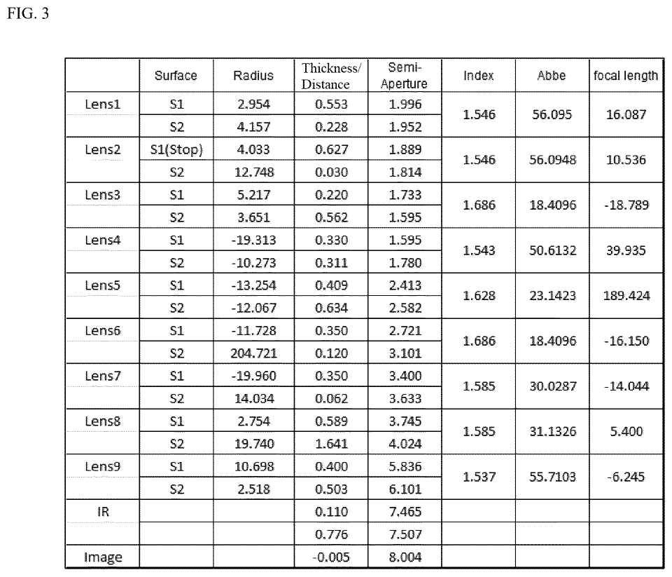

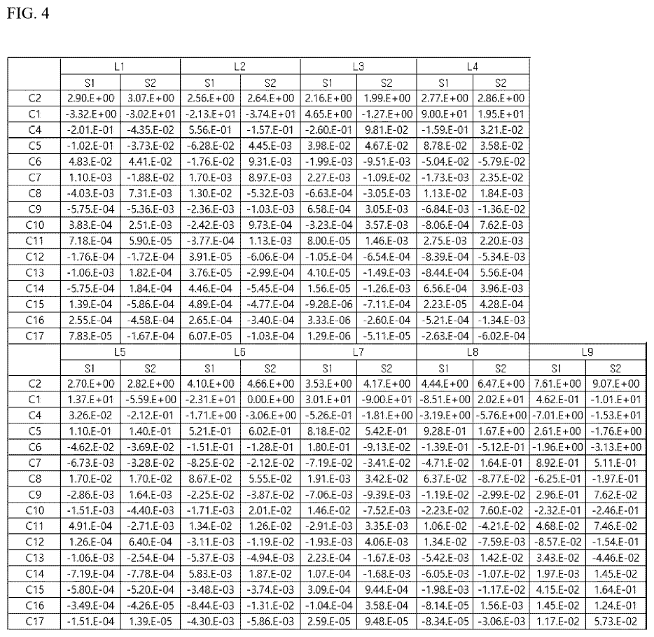

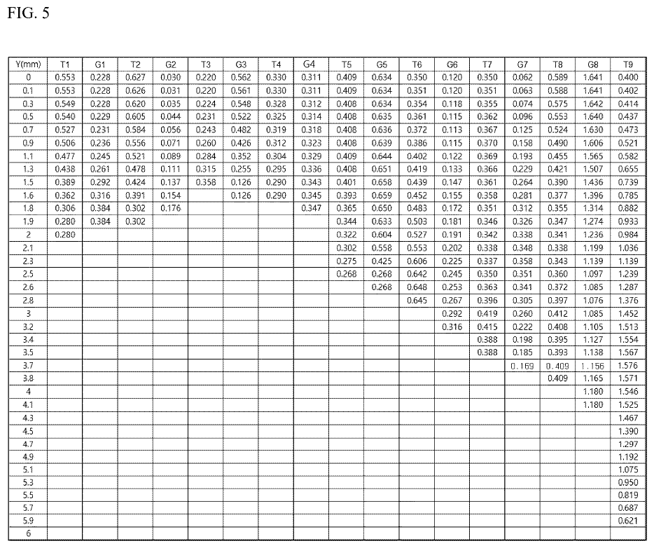

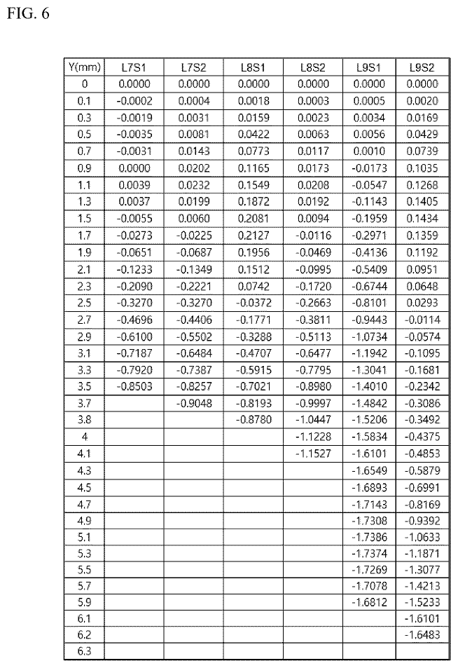

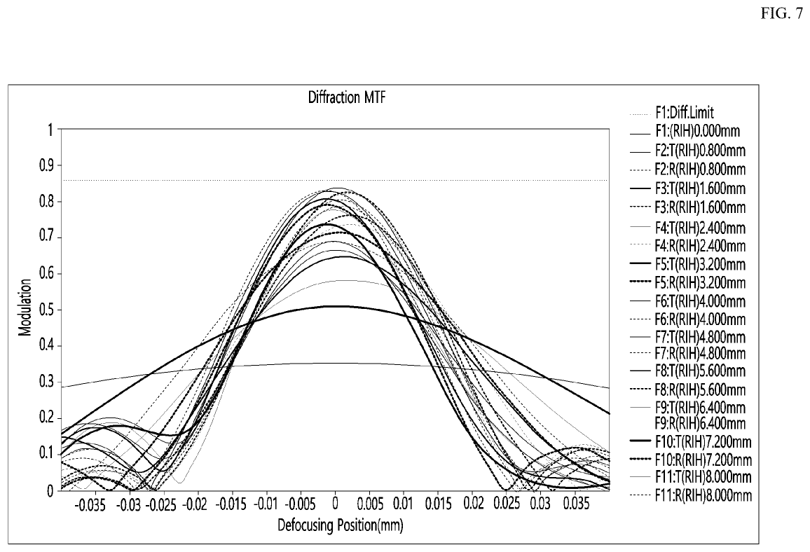

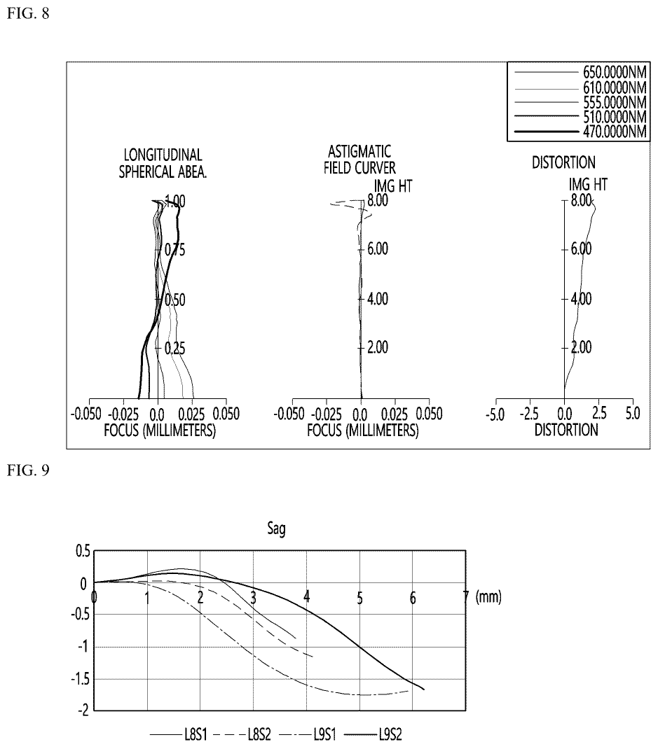

FIG. 1 is a configuration diagram of an optical system according to a first embodiment, FIG. 2 is an explanatory diagram illustrating a relationship among an image sensor, an n-th lens, and an n−1th lens in the optical system of FIG. 1, FIG. 3 is a table showing lens characteristics of the optical system of FIG. 1, FIG. 4 is a table showing aspheric coefficients of an object-side surface and a sensor-side surface of a lens of the optical system of FIG. 1, FIG. 5 is a table showing lens thicknesses and distances between adjacent lenses in a first direction Y orthogonal to the optical axis from an optical axis in the optical system of FIG. 1, FIG. 6 is a table showing Sag values of the object-side surface and the sensor-side surface of the n-th lens, the n−1th lens, and the n−2-th lens in the optical system of FIG. 1, FIG. 7 is a graph of diffraction MTF of the optical system of FIG. 1, FIG. 8 is a graph showing aberration characteristics of the optical system of FIG. 1, and FIG. 9 is a graph showing heights in the optical axis direction according to distances in the first direction Y with respect to the object-side surface and the sensor-side surface in the n-th lens and the n−1th lens of the optical system of FIG. 2.

Referring to FIGS. 1 and 2, an optical system 1000 according to an embodiment includes a plurality of lenses 100, and the plurality of lenses 100 may include first lenses 101 to ninth lenses 109. The first to ninth lenses 101 to 109 may be sequentially disposed along the optical axis OA of the optical system 1000. Light corresponding to object information may pass through the first lenses 101 to ninth lenses 109 and the filter 500 and be incident on the image sensor 300, and the first to third lenses 101-103 may refract or condense some incident light in the direction of the optical axis OA, and the fourth to ninth lenses 104-109 may transmit some light passing through the fourth lens 104 in a direction that spreads away from to the optical axis OA.

The first lens 101 may have positive (+) or negative (−) refractive power on the optical axis OA. The first lens 101 may have positive (+) refractive power. The first lens 101 may include a plastic or glass material. For example, the first lens 101 may be made of a plastic material. The first lens 101 may include a first surface S1 defined as an object-side surface and a second surface S2 defined as a sensor-side surface. On the optical axis OA, the first surface S1 may have a convex shape, and the second surface S2 may have a concave shape. That is, the first lens 101 may have a meniscus shape convex toward the object side on the optical axis OA. Alternatively, on the optical axis OA, the first surface S1 may have a convex shape, and the second surface S2 may have a convex shape. That is, the first lens 101 may have a convex shape on both sides of the optical axis OA. At least one of the first surface S1 and the second surface S2 may be an aspherical surface. For example, both the first surface S1 and the second surface S2 may be aspherical. Aspheric coefficients of the first and second surfaces S1 and S2 are provided as shown in FIG. 4, L1 is the first lens 101, and S1/S2 mean the first/second surfaces of L1.

The second lens 102 may have positive (+) or negative (−) refractive power on the optical axis OA. The second lens 102 may have positive (+) refractive power. The second lens 102 may include a plastic or glass material. For example, the second lens 102 may be made of a plastic material. The second lens 102 may include a third surface S3 defined as an object-side surface and a fourth surface S4 defined as a sensor-side surface. On the optical axis OA, the third surface S3 may have a convex shape, and the fourth surface S4 may have a concave shape. That is, the second lens 102 may have a meniscus shape convex toward the object side on the optical axis OA. Alternatively, on the optical axis OA, the third surface S3 may have a convex shape, and the fourth surface S4 may have a convex shape. That is, the second lens 102 may have a convex shape on both sides of the optical axis OA. At least one of the third and fourth surfaces S3 and S4 may be an aspherical surface. For example, both the third surface S3 and the fourth surface S4 may be aspheric surfaces. Aspheric coefficients of the third and fourth surfaces S3 and S4 are provided as shown in FIG. 4, L2 is the second lens 102, and S1/S2 of L2 mean the first/second surfaces of L2.

The third lens 103 may have positive (+) or negative (−) refractive power on the optical axis OA. The third lens 103 may have negative (−) refractive power. The third lens 103 may include plastic or glass. For example, the third lens 103 may be made of plastic. The third lens 103 may include a fifth surface S5 defined as the object side surface and a sixth surface S6 defined as the sensor side surface. On the optical axis OA, the fifth surface S5 may have a convex shape, and the sixth surface S6 may have a concave shape. That is, the third lens 103 may have a meniscus shape that is convex toward the object on the optical axis OA. Alternatively, on the optical axis OA, the fifth surface S5 may have a concave shape, and the sixth surface S6 may have a concave shape.

At least one of the fifth surface S5 and the sixth surface S6 may be an aspherical surface. For example, both the fifth surface S5 and the sixth surface S6 may be aspherical. The aspherical coefficients of the fifth and sixth surfaces S5 and S6 are provided as shown in FIG. 4, where L3 is the third lens 103, and S1/S2 of L3 mean the first/second surfaces of L3.

The refractive index n3 of the third lens 103 may be the largest among the first to third lenses 101, 102, and 103 and may satisfy: 1.6<n3. The Abbe number of the third lens 103 may be the smallest among the first to third lenses 101, 102, and 103, and may be less than 30 or less than 25. For example, the Abbe number of the third lens 103 may be 20 or more smaller than the Abbe numbers of the first and second lenses 101 and 102. Abbe numbers of the first and second lenses 101 and 102 may be 45 or more. Accordingly, the optical system 1000 may have improved chromatic aberration control characteristics.

As for the effective diameters of the first to third lenses 101, 102, and 103, the first lens 101 may be the largest and the third lens 103 may be the smallest. Here, the effective diameter is the average of the effective diameters of the object-side surface and the sensor-side surface of each lens. Effective diameters of the first to third lenses 101, 102, and 103 may be 5 mm or less. The curvature radius of each of the first to third lenses 101, 102, and 103 may be less than 50 mm, for example, less than 40 mm or less than 30 mm, preferably less than 10 mm. Here, the curvature radius is the average of the radii of curvature of the object-side surface and the sensor-side surface of each lens. By providing the curvature radius of the first to third lenses 101, 102, and 103 to be less than 50 mm, light incidence efficiency may be improved.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be made of a plastic material. The fourth lens 104 may include a seventh surface S7 defined as an object-side surface and an eighth surface S8 defined as a sensor-side surface. On the optical axis OA, the seventh surface S7 may have a concave shape, and the eighth surface S8 may have a convex shape. That is, the fourth lens 104 may have a meniscus shape convex toward the sensor on the optical axis OA. Alternatively, the seventh surface S7 may have a concave shape on the optical axis OA, and the eighth surface S8 may have a concave shape on the optical axis OA. At least one of the seventh surface S7 and the eighth surface S8 may be an aspherical surface. For example, both the seventh surface S7 and the eighth surface S8 may be aspheric surfaces. Aspheric coefficients of the seventh and eighth surfaces S7 and S8 are provided as shown in FIG. 4, L4 is the fourth lens 104, and S1/S2 of L4 mean the first/second surfaces of L4.

The fifth lens 105 may have positive (+) or negative (−) refractive power on the optical axis OA. The fifth lens 105 may have positive (+) refractive power. The fifth lens 105 may include a plastic or glass material. For example, the fifth lens 105 may be made of a plastic material. The fifth lens 105 may include a ninth surface S9 defined as an object-side surface and a tenth surface S10 defined as a sensor-side surface. On the optical axis OA, the ninth surface S9 may have a concave shape, and the tenth surface S10 may have a convex shape. That is, the fifth lens 105 may have a meniscus shape convex toward the sensor on the optical axis OA. Alternatively, the ninth surface S9 may have a concave shape on the optical axis OA, and the tenth surface S10 may have a concave shape on the optical axis OA. Alternatively, the ninth surface S9 may have a convex shape on the optical axis OA, and the tenth surface S10 may have a concave or convex shape on the optical axis OA. At least one of the ninth surface S9 and the tenth surface S10 may be an aspherical surface. For example, both the ninth surface S9 and the tenth surface S10 may be aspheric surfaces. Aspherical coefficients of the ninth and tenth surfaces S9 and S10 are provided as shown in FIG. 4, L5 is the fifth lens 105, and S1/S2 of L5 mean the first/second surfaces of L5.

The sixth lens 106 may have positive (+) or negative (−) refractive power on the optical axis OA. The sixth lens 106 may have negative (−) refractive power. The sixth lens 106 may include a plastic or glass material. For example, the sixth lens 106 may be made of a plastic material. The sixth lens 106 may include an eleventh surface S11 defined as an object-side surface and a twelfth surface S12 defined as a sensor-side surface. The eleventh surface S11 may have a concave shape on the optical axis OA, and the twelfth surface S12 may have a concave shape on the optical axis OA. That is, the sixth lens 106 may have a concave shape on both sides of the optical axis OA. Alternatively, the eleventh surface S11 may have a concave shape on the optical axis OA, and the twelfth surface S12 may have a convex shape on the optical axis OA. Alternatively, the sixth lens 106 may have a convex shape on both sides of the optical axis OA. At least one of the eleventh surface S11 and the twelfth surface S12 may be an aspheric surface. For example, both the eleventh surface S11 and the twelfth surface S12 may be aspherical surfaces. The aspherical coefficients of the eleventh and twelfth surfaces S11 and S12 are provided as shown in FIG. 4, L6 is the sixth lens 106, and S1/S2 of L6 mean the first/second surfaces of L6.

The seventh lens 107 may have positive (+) or negative (−) refractive power on the optical axis OA. The seventh lens 107 may have negative (−) refractive power. The seventh lens 107 may include a plastic or glass material. For example, the seventh lens 107 may be made of a plastic material. The seventh lens 107 may include a thirteenth surface S13 defined as an object-side surface and a fourteenth surface S14 defined as a sensor-side surface. The thirteenth surface S13 may have a concave shape on the optical axis OA, and the fourteenth surface S14 may have a concave shape on the optical axis OA. Alternatively, the seventh lens 107 may have a convex meniscus shape toward the sensor side or the object side. Alternatively, the seventh lens 107 may have a convex shape on both sides. At least one of the thirteenth surface S13 and the fourteenth surface S14 may be an aspheric surface. For example, both the thirteenth surface S13 and the fourteenth surface S14 may be aspheric surfaces. The aspheric coefficients of the thirteenth and fourteenth surfaces S13 and S14 are provided as shown in FIG. 4, L7 is the seventh lens 107, and S1/S2 of L7 mean the first/second surfaces of L7.

The eighth lens 108 may have positive (+) or negative (−) refractive power on the optical axis OA. The eighth lens 108 may have positive (+) refractive power. The eighth lens 108 may include a plastic or glass material. For example, the eighth lens 108 may be made of a plastic material. The eighth lens 108 may include a fifteenth surface S15 defined as an object-side surface and a sixteenth surface S16 defined as a sensor-side surface. The fifteenth surface S15 may have a convex shape on the optical axis OA, and the sixteenth surface S16 may have a concave shape on the optical axis OA. That is, the eighth lens 108 may have a meniscus shape convex toward the object side on the optical axis OA. Alternatively, the fifteenth surface S15 may have a convex shape on the optical axis OA, and the sixteenth surface S16 may have a convex shape on the optical axis OA. That is, the eighth lens 108 may have a convex shape on both sides. The eighth lens 108 may have a meniscus shape convex toward the sensor or a concave shape on both sides. At least one of the fifteenth surface S15 and the sixteenth surface S16 may be an aspheric surface. For example, both the fifteenth surface S15 and the sixteenth surface S16 may be aspheric surfaces. The aspheric coefficients of the fifteenth and sixteenth surfaces S16 and S16 are provided as shown in FIG. 4, L8 is the eighth lens 108, and S1/S2 of L8 means the first/second surfaces of L8.

The ninth lens 109 may have positive (+) or negative (−) refractive power on the optical axis OA. The ninth lens 109 may have negative (−) refractive power. The ninth lens 109 may include a plastic or glass material. For example, the ninth lens 109 may be made of a plastic material. The ninth lens 109 may include a seventeenth surface S17 defined as an object-side surface and an eighteenth surface S18 defined as a sensor-side surface. The seventeenth surface S17 may have a convex shape on the optical axis OA, and the eighteenth surface S18 may have a concave shape on the optical axis OA. That is, the ninth lens 109 may have a meniscus shape convex toward the object side on the optical axis OA. Alternatively, the seventeenth surface S17 may have a concave shape on the optical axis OA, and the eighteenth surface S18 may have a convex shape on the optical axis OA. Alternatively, the ninth lens 109 may have a concave shape on both sides of the optical axis OA. At least one of the seventeenth surface S17 and the eighteenth surface S18 may be an aspheric surface. For example, both the seventeenth surface S17 and the eighteenth surface S18 may be aspheric surfaces. The aspheric coefficients of the seventeenth and eighteenth surfaces S17 and S18 are provided as shown in FIG. 4, L9 is the ninth lens 109, and S1/S2 of L9 means the first/second surfaces of L9.

The first lens group LG1 may include the first to third lenses 101, 102, and 103, and the second lens group LG2 may include the fourth to ninth lenses 104, 105, 106, 107, 108, and 109. The optical axis distance TD from the object-side surface of the first lens 101 to the sensor-side surface of the ninth lens 109 satisfies: TD≤10 mm, for example, 7 mm≤TD≤10 mm. The optical axis distance from the object-side surface of the fourth lens 104 to the sensor-side surface of the ninth lens 109 may be 65% or more of the TD, for example, in arrange of 65% to 75%.

In the following description, CT1 to CT9 mean the center thickness of the first to ninth lenses 101 to 109, ET1 to ET9 mean edge thicknesses of the first to ninth lenses 101 to 109, CG1 to CG8 may mean a center distance between the first to ninth lenses 101 to 109, and EG1 to EG8 may mean an edge distance between the first to ninth lenses 101 to 109.

Among the lenses 100, the minimum center thickness CT_Min of each lens satisfies: CT_Min<0.3 mm, and the maximum center thickness CT_Max may be more than twice the minimum center thickness, and for example, satisfy the following Equation: 0.6 mm≤CT_Max. Here, the minimum center thickness of each lens is the center thickness CT4 of the fourth lens 104, and the maximum center thickness is the center thickness CT2 of the second lens 102.

The center thickness CT9 of the ninth lens 109 may be greater than the center thicknesses CT3 and CT4 of the third and fourth lenses 103 and 104 and may be smaller than the center thickness CT8 of the eighth lens 108. The difference between the center thickness CT8 of the eighth lens 108 and the center thickness CT9 of the ninth lens 109 may satisfy the following Equation: CT8−CT9≤0.15 mm. Accordingly, the optical system 1000 may control incident light and may have improved aberration characteristics and resolution.

The edge thickness ET9 of the ninth lens 109 is the maximum among the edge thicknesses of the lenses, and may satisfy the following Equation: ET9>CT9. In addition, the first and second lenses 101 and 102 may satisfy the following Equations: ET1<CT1 and ET2<CT2, and the third lens 103 may satisfy the following Equation: ET3>CT3.

At least one of edge thicknesses of the first, second, third, or fourth lenses 101, 102, 103, and 104 may be a minimum edge thickness. The maximum edge thickness may be at least 1.5 times the minimum edge thickness, for example, in the range of 1.5 times to 4 times. Here, the edge thickness is a distance in the optical axis between the end of the effective region of the object-side surface of each lens and the end of the effective region of the sensor-side surface of each lens.

Among the lenses 100, the minimum center distance CG_Min between two adjacent lenses satisfies the following Equation: CG<0.1 mm, the maximum center distance CG_Max may satisfy the following Equation: CG_Max≥1.3 mm, and the maximum center distance may be greater than 10 times or more than 20 times the minimum center distance. Here, the minimum center distance CG_Min is a distance in the optical axis between the sixth and seventh lenses 106 and 107, and the maximum center distance CG_Max is a distance in the optical axis between the eighth and ninth lenses 108 and 109. Accordingly, the optical system 1000 may control incident light and may have improved aberration characteristics and resolution.

As for the edge distances between the lenses 100, the edge distance EG3 of the third and fourth lenses 103 and 104 may be minimum, and the edge distance EG8 of the eighth and ninth lenses 108 and 109 may be maximum. The edge distance is a distance in the optical axis between an end of an effective region of a sensor-side surface of an object-side lens and an end of an effective region of an object-side surface of an adjacent lens. The maximum edge distance may be 5 times or more than the minimum edge distance.

Among the lenses 100, the effective radius (Semi-aperture) may gradually decrease from the first surface S1 of the first lens 101 to the sensor-side sixth surface S6 of the third lens 103 or the object-side seventh surface S7 of the lens 104. Also, the effective radius may gradually increase from the object-side seventh surface S7 of the fourth lens 104 to the eighteenth surface S18 of the ninth lens 109. Here, the effective radius is a straight length from the optical axis OA to the end of the effective region in a direction orthogonal to the optical axis OA, and the effective radius of each lens is the average value of the effective radii of the object-side surface and the sensor-side surface of each lens. Among the object-side surfaces and the sensor-side surfaces, the minimum effective radius may be the effective radius of the sensor-side surface S6 of the third lens 103, and the maximum effective radius may be the sensor-side surface S18 of the ninth lens 109. The maximum effective radius may be 2.2 times or more, for example, 2.2 times to 5 times the minimum effective radius. The effective radius r11 of the first surface S1 of the first lens 101 is greater than the effective radii of the second to sixth surfaces S2-S6, so that light may be guided without loss. The size of the effective radius r92 of the sensor-side eighteenth surface S17 of the ninth lens 109 is the largest, so that incident light may be refracted to the entire region of the image sensor 300. Accordingly, the optical system 1000 may have improved chromatic aberration control characteristics, and may improve vignetting characteristics of the optical system 1000 by controlling incident light.

Regarding the Abbe number, the maximum Abbe number Vd_Max and the minimum Abbe number Vd_Min of each lens may satisfy the following Equation: Vd_Max−Vd_min≥20, and may satisfy: Vd_Max≥45, for example, Vd_Max≥50. A lens having an Abbe number (Vd) of 45 or more in the optical system 1000 satisfies the following Equation: 4/nL, where nL is the number of lenses and is in the range of 8 to 10. Accordingly, the optical system 1000 may have improved chromatic aberration control characteristics.

Regarding the refractive index, the maximum refractive index nd_Max of each lens may satisfy the following Equation: nd_Max>1.6, and the difference between the maximum refractive index nd_Max and the minimum refractive index nd_Min may satisfy the following Equation: nd_Max−nd_Min≥0.07. The number of lenses having a refractive index of 1.6 or more may satisfy: 3/nL, and the number of lenses having a refractive index of less than 1.6 may satisfy: nL-3/nL. The lenses having a refractive index of 1.6 or more may be the third, fifth, and sixth lenses 103, 105, and 106. Accordingly, the optical system 1000 may have improved chromatic aberration control characteristics.

In the absolute value of the effective focal length EFL, the maximum focal length F_Max is, for example, 100 or more, and a lens having a focal length of 50 or more or 70 or more is 1/nL, and a lens with the maximum focal length is a fifth lens 105, the minimum focal length may be less than 10, and a lens having a focal length of 20 or less may satisfy: 6/nL. The average F_Aver of the focal lengths of each lens may be 20 or more, for example, in the range of 20 to 32.

In the absolute value of the curvature radii, the maximum curvature radius is, for example, 150 mm or more, the lens having a curvature radius of 120 mm or more is 1/nL, the lens surface having the maximum curvature radius may be the twelfth surface S12, and the minimum curvature radius may be 3 or less, and the lens surface having the minimum curvature radius may be the eighteenth surface S18.

In the critical point of the plurality of lenses 100, the object-side surface and the sensor-side surface of the first to fourth lenses 101 to 104 may be provided without a critical point. Alternatively, an object-side surface or/and a sensor-side surface of at least one of the first to fourth lenses 101 to 104 may have a critical point. At least one or both of the object-side surface and the sensor-side surface of the fifth lens 105 may be provided without a critical point or may have at least one critical point. At least one or both of the object-side surface and the sensor-side surface of the sixth lens 106 may be provided without a critical point or may have at least one critical point.

The critical points of the lens surfaces of the seventh to ninth lenses refer to the height of the Sag of each lens surface in FIG. 6.

The thirteenth surface S13 of the seventh lens 107 is L7S1 and may have at least one critical point, the critical point may be located in a range of 27% or less of an effective radius with respect to the optical axis OA, for example, in a range of 7% to 27% or in a range of 12% and 22%. The fourteenth surface S14 of the seventh lens 107 is L7S2 and may have at least one critical point, the critical point may be located in a range of 42% or less of an effective radius with respect to the optical axis OA, for example, in a range of 22% to 42% or in a range of 27% and 37%. The seventh lens 107 having the critical point may refract the incident light outward and emit it.

As shown in FIG. 2, the fifteenth and sixteenth surfaces S15 and S16 of the eighth lens 108 are L8S1 and L8S2, and at least one or both of them may have a critical point. For example, both of the fifteenth and sixteenth surfaces S15 and S16 may have critical points. The first critical point P1 of the fifteenth surface S15 may be located at a distance Inf81 of 32% or more of the effective radius r81 of the fifteenth surface S15 from the optical axis OA, for example, in a range of 32% to 52% or in the range of 37% to 47%. The first critical point P1 may be a point closest to the image sensor 300 on the fifteenth surface S15.

The critical point of the sixteenth surface S16 of the eighth lens 108 may be located at a distance of 19% or more of the effective radius of the sixteenth surface S16 from the optical axis OA, for example, in a range of 19% to 39% or in a range of 14% to 24%. Accordingly, the fifteenth and sixteenth surfaces S15 and S16 may refract light incident through the seventh lens 107 outward. The positions of the critical points of the fifteenth and sixteenth surfaces S15 and S16 may be disposed further outside than the critical point of the thirteenth surface S13 of the seventh lens 107 based on the optical axis OA.

In the ninth lens 109, the seventeenth and eighteenth surfaces S17 and S18 are L9S1 and L9S2, and at least one or all of them may have at least one critical point. For example, the seventeenth surface S17 may be located at a distance of 18% or less of the effective radius of the seventeenth surface S17 from the optical axis OA, for example, in a range of 5% to 18% or in a range of 5% to 13%. The critical point of the seventeenth surface S17 may be disposed within a distance of 1 mm or less from the optical axis OA or may be located within a range of 0.3 mm to 0.8 mm. The seventeenth surface S17 may be provided without a critical point.

The second critical point P2 of the eighteenth surface S18 of the ninth lens 109 may be located at a distance Inf92 less than or equal to 34% of the effective radius r92 of the eighteenth surface S18 from the optical axis OA, for example, in the range of 14% to 34% or in the range of 19% to 29%. Accordingly, the seventeenth and eighteenth surfaces S17 and S18 may refract the light refracted through the eighth lens 108 to the periphery portion of the image sensor 300. Here, the second critical point P2 may be a point closest to the image sensor 300 on the eighteenth surface S18. It may mean a point where the slope of the normal line K2 and the optical axis OA is zero on the eighteenth surface S18. In addition, the second critical point P2 may refer to a point where the slope between the tangent line K1 and the imaginary line K2 extending in the vertical direction of the optical axis OA on the eighteenth surface S18 is 0 degrees. Here, a normal line K2 passing through an arbitrary point on the sensor-side eighteenth surface S18 of the ninth lens 109 may have a predetermined angle θ1 with the optical axis OA. The angle θ1 may be less than 65 degrees at most.

Here, the maximum angle of the tangent line passing through the fifteenth surface S15 of the eighth lens 108 may be greater than the maximum angle of the tangent line passing through the eighteenth surface S18 of the ninth lens 109. The maximum angle of a tangent line passing through the sixteenth surface S16 of the eighth lens 108 may be greater than the maximum angle of a tangent line passing through the eighteenth surface S18 of the ninth lens 109. The maximum angle of a tangent line passing through the seventeenth surface S17 of the ninth lens 109 may be greater than the maximum angle of a tangent line passing through the eighteenth surface S18 of the ninth lens 109.

FIG. 9 is a graph showing the heights of the sag of each lens surface of the eighth lens and the ninth lens, where L8S1 and L8S2 represent the fifteenth surface S15 and the sixteenth surface S16 of the eighth lens 108, and L9S1 and L9S2 represent the seventeenth surface S17 and the eighteenth surface S18 of the ninth lens 109. As shown in FIG. 9, it may be seen that L8S1, L8S2, L9S1, and L9S2 have all critical points within 2.5 mm or less from the optical axis. The height of the Sag is the height of the lens surface in a straight line orthogonal to the center of each lens surface. The critical point of the L8S1 may be located further outside than the critical points of the object side and sensor-side surfaces of the eighth lens 108 based on the optical axis. It may be seen that the critical point of L9S2, which is the eighteenth surface of the ninth lens 109, is located within 2 mm or less than 2 mm from the center (e.g., 0) or in the range of 1 mm to 2 mm, when viewed on the basis of a straight line orthogonal to the center (e.g., 0).

It is preferable that the position of the critical points of the eighth and ninth lenses 108 and 109 is disposed at a position satisfying the above-described range in consideration of the optical characteristics of the optical system 1000. In detail, the location of the critical points preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics not only at the center portion of the FOV but also at the periphery portion.

As shown in FIG. 2, CT9 is the center thickness or the optical axis thickness of the ninth lens 109, and ET9 is the end or edge thickness of the effective region of the ninth lens 109. CT8 is the center thickness or the optical axis thickness of the eighth lens 108, and ET8 is the end or edge thickness of the effective region of the eighth lens 108. The edge thickness ET8 of the eighth lens 108 is a distance from the end of the effective region of the fifteenth surface S15 to the effective region of the sixteenth surface S16 in a direction of the optical axis. The edge thickness ET9 of the ninth lens 109 is a distance from the end of the effective region of the seventeenth surface S17 to the effective region of the eighteenth surface S18 in a direction of the optical axis. CG8 is the optical axis distance (e.g., center distance) from the center of the sensor-side surface of the eighth lens 108 to the center of the object-side surface of the ninth lens 109. That is, CG8 is the distance between the sixteenth surface S16 and the seventeenth surface S17 in the optical axis OA. In the same way, EG8 is the distance (e.g., the edge distance) in a direction of the optical axis from the edge of the eighth lens 108 to the edge of the ninth lens 109. That is, EG8 is the distance in a direction of the optical axis between a straight line extending outward from the end of the effective region of the sixteenth surface S16 and the end of the effective region of the seventeenth surface S17. Here, the distance between the ends of the effective region between adjacent lens surfaces is an optical axis distance between a straight line extending from an end having a short effective radius and an end of the effective region facing the straight line. A back focal length (BFL) is an optical axis distance from the image sensor 300 to the last lens.

In this way, the center thickness and edge thickness of the first to ninth lenses 101 to 109, and the center distance and edge distance between two adjacent lenses may be set. For example, as shown in FIGS. 1 and 5, the thickness T1-T9 of each lens and the distances G1-G8 between adjacent lenses may be provided. For example, T1-T9 represents the first to ninth thicknesses of the first to ninth lenses 101 to 109 in a region spaced apart by a predetermined distance (e.g., 0.1 mm or more) along the first direction Y with respect to the optical axis OA. In addition, the distance between the first lens 101 and the second lens 102 is the first distance G1, the distance between the second lens 102 and the third lens 103 is the second distance G2, the distance between the third lens 103 and the fourth lens 104 is the third distance G3, the distance between the fourth lens 104 and the fifth lens 105 is the fourth distance G4, the distance between the fifth lens 105 and the sixth lens 106 is the fifth distance G5, the distance between the sixth lens 106 and the seventh lens 107 is the sixth distance G6, the distance between the the seventh lens 107 and the eighth lens 108 is the seventh distance G7, and the distance between the eighth lens 108 and the ninth lens 109 may be an eighth distance G8. The first direction Y may include a circumferential direction centered on the optical axis OA or two directions orthogonal to each other, and the distance between two adjacent lenses at the ends of the first direction Y is an effective radius. The end of the effective region of the smaller lens may be a reference, and the end of the effective radius may include an error of the end ±0.2 mm, and may be an edge.

The first thickness T1 may gradually decrease from the center to the edge of the first lens 101, and the center thickness of the first lens 101 may be more than 1 times the edge thickness, for example, in the range of 1.1 to 4 times.

The second thickness T2 may gradually increase from the center to the edge of the second lens 102, and the edge thickness of the second lens 102 may be more than 1 times the center thickness, for example, in the range of 1.1 to 4 times.

The third thickness T3 may gradually increase from the center to the edge of the third lens 103, and the maximum of the third thickness T3 may be greater than the minimum of the first and second thicknesses T1 and T2 and may be smaller than the maximum of the first and second thicknesses T1 and T2. The maximum of the third thickness T3 may be 1.1 times or more, for example, in the range of 1.1 to 2.1 times the minimum.

The fourth thickness T4 may gradually become thinner from the center to the edge of the fourth lens 104, and the maximum of the fourth thickness T4 may be smaller than the maximum of the third thickness T3 and greater than the minimum. The maximum of the fourth thickness T4 may be one or more times, for example, one to two times the minimum.

The fifth thickness T5 may gradually decrease from the center to the edge of the fifth lens 105, and the maximum of the fifth thickness T5 may be greater than the maximum of the third and fourth thicknesses T3 and T4 and smaller than the maximum of the second thickness T2. The maximum of the fifth thickness T5 may be 1.1 times or more, for example, in the range of 1.1 to 2.1 times the minimum.

The sixth thickness T6 may gradually increase from the center to the edge of the sixth lens 106, the maximum of the sixth thickness T6 may be a region adjacent to the edge, and the minimum may be at the center thickness. The maximum of the sixth thickness T6 may be greater than the maximum of the second thickness T2. The maximum of the sixth thickness T6 may be 1.3 times or more, for example, in the range of 1.3 to 2.3 times the minimum.

The seventh thickness T7 may gradually increase from the center to the edge of the seventh lens 107, the maximum of the seventh thickness T7 may be a region adjacent to the edge, and the minimum may be the center thickness. The maximum of the seventh thickness T7 may be greater than the minimum of the sixth thickness T6 and smaller than the maximum. The maximum of the seventh thickness T7 may be one or more times, for example, one to two times the minimum.

The eighth thickness T8 may be the maximum at the center of the eighth lens 108 and may be minimum within 2.1 mm±0.3 mm from the optical axis OA, and the maximum of the eighth thickness T8 may be smaller than the maximum of the second thickness T2 and greater than the maximum of the seventh thickness T7. The maximum of the eighth thickness T8 may be 1.2 times or more, for example, in a range of 1.2 to 2.2 times the minimum.

The ninth thickness T9 may be minimum at the center of the ninth lens 109 and maximum within 3.3 mm±0.3 mm from the optical axis OA, and the maximum of the ninth thickness T9 may be greater than the maximum of first to eighth thicknesses T1-T8. The maximum of the ninth thickness T9 may be 3.1 times or more, for example, in the range of 3.1 times to 5.1 times the minimum.

In the first distance G1, a center distance between the first lens 101 and the second lens 102 may be minimum and an edge distance may be maximum along the first direction Y. The maximum of the first distance G1 may be 1.1 times or more, for example, 1.1 times to 2 times the minimum. Accordingly, the optical system 1000 may effectively control incident light, and light incident through the first and second lenses 101 and 102 may proceed to other lenses by the first distance G1 and maintain good optical performance.

The second distance G2 may be a distance between the second lens 102 and the third lens 103 in the optical axis direction Z. The second distance G2 may be minimum at the optical axis OA and maximum on the edge. The maximum of the second distance G2 may be less than the minimum of the second thickness T2 and may be 4 times or more, for example, 4 to 7 times the minimum of the second distance G2. The maximum of the second distance G2 may be smaller than the minimum of the first distance G1. Accordingly, the optical system 1000 may have improved optical characteristics, and aberration characteristics of the optical system 1000 may be improved by the second distance G2.

The third distance G3 may be a distance between the third lens 103 and the fourth lens 104 in the optical axis direction Z. The third distance G3 may be maximum at the center and minimum at the edge, and the maximum may be 5 times or more, for example, 5 to 15 times the minimum. The maximum of the third distance G3 may be greater than the maximum of the first distance G1, and the minimum may be less than the minimum of the first distance G1. Accordingly, the optical system 1000 may have improved chromatic aberration characteristics and control vignetting characteristics by the third distance G3. The third distance G3 may be a distance between the first and second groups LG1 and LG2.

The fourth distance G4 may be a distance between the fourth lens 104 and the fifth lens 105 in the optical axis direction Z. The fourth distance G4 may be minimum at the center CG4 and maximum at the edge EG4. The center distance CG4 of the fourth distance G4 may satisfy: CT4<CG4<CT5. The maximum of the fourth distance G4 may be one or more times, for example, one to two times the minimum.

The fifth distance G5 may be a distance between the fifth lens 105 and the sixth lens 106 in the optical axis direction Z. The minimum of the fifth distance G5 may be an edge distance, and the maximum may be a distance within 1.3 mm±0.3 mm from the optical axis OA. The maximum of the fifth distance G5 may be 1.4 times or more, for example, in the range of 1.4 to 3.4 times or in the range of 1.9 to 2.9 times the minimum. The maximum of the fifth distance G5 may be greater than the maximum of the second thickness CT2, and the minimum of the fifth distance G5 may be less than the minimum of the second thickness CT2. Accordingly, the optical system 1000 may have improved optical characteristics, and may have good optical performance in the center and periphery portions of the FOV due to the fourth and fifth distances G4 and G5, and may be adjusted improved chromatic aberration and distortion.

The sixth distance G6 may be a distance between the sixth lens 106 and the seventh lens 107 in the optical axis direction. The maximum of the sixth distance G6 may be located near the edge or within 3.1 mm±0.3 mm from the optical axis OA, and the minimum may be located within 0.7 mm±0.3 mm from the optical axis OA. The maximum of the sixth distance G6 may be 1.7 times or more, for example, in the range of 1.7 to 3.7 times the minimum.

The seventh distance G7 may be an optical axis direction distance between the seventh lens 107 and the eighth lens 108. The seventh distance G7 may be minimum at the center and maximum within 2.3 mm±0.3 mm from the optical axis OA. The maximum of the seventh distance G7 may be 4 times or more, for example, 4 to 7 times the minimum. The maximum of the seventh distance G7 may be greater than the maximum of the sixth distance G6 and may be smaller than the maximum thickness of the seventh lens 107. Accordingly, the optical system 1000 may have improved optical characteristics in the center and periphery portions of the FOV. In addition, the optical system 1000 may have improved aberration control characteristics as the seventh lens 107 and the eighth lens 108 are spaced at a seventh distance G7 set according to positions, and the size of the effective diameter of the ninth lens 109 may be appropriately controlled.

The eighth distance G8 may be a distance in an optical axis direction between the eighth lens 108 and the ninth lens 109. The eighth distance G8 may be minimum within 0.3 mm±0.3 mm and maximum within 2.8 mm±0.3 mm from the optical axis OA. The maximum of the eighth distance G8 may be equal to or greater than the maximum of the ninth thickness CT9, and may be 1.1 times or more, for example, in the range of 1.1 to 2.1 times the minimum of the eighth distance G8. Distortion characteristics and aberration characteristics may be improved at the center and periphery portions the FOV by the eighth distance G8.

Among the plurality of lenses 100, the number of lenses having a center thickness of less than 0.5 mm may be greater than the number of lenses having a center thickness of 0.5 mm or more. Among the plurality of lenses 100, the number of lenses having the center thickness smaller than 0.5 mm may be 5 or less, and the number of lenses having the center thickness larger than 0.5 mm may be 4 or more. Accordingly, the optical system 1000 may be provided with a structure having a slim thickness. Among the plurality of lens surfaces S1 to S18, the number of surfaces having an effective radius of 3.0 mm or less may be smaller than the number of surfaces having an effective radius of 3.0 mm or more, for example, 5 or less. Describing the curvature radius as an absolute value, the curvature radius of the twelfth surface S12 of the sixth lens 106 among the plurality of lenses 100 may be the largest among the lens surfaces, and the maximum curvature radius may be 50 times or more of the curvature radius of the eighteenth surface S18 having the minimum curvature radius. Describing the focal length as an absolute value, the focal length of the sixth lens 106 among the plurality of lenses 100 may be the largest among the lenses, and the maximum focal length may be 20 times or more of the distance the focal length of the ninth lens 109 having the minimum focal length.

As shown in FIG. 3, the curvature radius, the center thickness (unit: mm) of the lenses, the center distance (unit: mm) between the lenses on the optical axis OA of the first to ninth lenses 101 to 109 of FIG. 1, the refractive index in the d-line, the Abbe Number, the size of the effective radius, and the focal length are shown. In an embodiment of the invention, the F number may be 1.5 or more, for example, in the range of 1.5 to 2.5 or in the range of 1.7 to 2.3.

As shown in FIG. 4, in the embodiment, at least one lens surface among the plurality of lenses 100 may include an aspherical surface having a 30th order aspherical surface coefficient. For example, the first to ninth lenses 101 to 109 may include lens surfaces having a 30th order aspheric coefficient. As described above, an aspherical surface having a 30th order aspheric coefficient (a value other than “0”) may change the aspherical shape of the peripheral portion particularly greatly, so that the optical performance of the peripheral portion of the FOV may be well corrected.

FIG. 7 is a graph of diffraction MTF characteristics of the optical system 1000 according to the first embodiment, and FIG. 8 is a graph of aberration characteristics. In aberration graph in FIG. 8, it is a graph in which spherical aberration, astigmatic field curves, and distortion are measured from left to right. In FIG. 7, the X-axis may represent a focal length (unit: mm) and distortion (%), and the Y axis may represent the height of an image. In addition, the graph for spherical aberration is a graph for light in a wavelength band of about 470 nm, about 510 nm, about 555 nm, about 610 nm, and about 650 nm, and the graph for astigmatism and distortion aberration is a graph for light in a wavelength band of about 555 nm.

In the aberration diagram of FIG. 8, it may be interpreted that the aberration correction function is better as each curve approaches the Y-axis. That is, the optical system 1000 according to the embodiment may have improved resolution and good optical performance not only at the center portion of the FOV but also at the periphery portion.

Among the lenses 100 of the optical system 1000 according to the above-described embodiment, the number of lenses having an Abbe number of 45 or more, for example, in the range of 45 to 70 may be four, and the number of lenses having a refractive index of 1.6 or more, for example, in the range of 1.6 to 1.8 may be 3 lenses. Accordingly, the optical system 1000 may implement good optical performance in the center and periphery portions of the FOV and have improved aberration characteristics.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the FOV but also in the periphery portion. The optical system 1000 may have improved resolving power and may have a slimmer and more compact structure.

$$0 < CT 1 / CT 2 < 2 \qquad [ Equation 1 ]$$

When Equation 1 satisfies the thickness CT1 of the first lens 101 in the optical axis OA and the thickness CT2 of the second lens 102 in the optical axis OA, the optical system 1000 may improve aberration characteristics.

$$1 < CT 3 / ET 3 < 3 \qquad [ Equation 2 ]$$

When Equation 2 satisfies the thickness CT3 of the third lens 103 in the optical axis OA and the thickness ET3 at the end of the effective region of the third lens 103, the optical system 1000 may have improved chromatic aberration control characteristics.

$$1 < CT 1 / ET 1 < 5 \qquad [ Equation 2 - 1 ]$$

$$1 < CT 2 / ET 2 < 5 \qquad [ Equation 2 - 2 ]$$

$$1.1 < CT 3 / ET 3 < 3 \qquad [ Equation 2 - 3 ]$$

$$1 \leq CT 4 / ET 4 < 3 \qquad [ Equation 2 - 4 ]$$

$$1.1 < CT 5 / ET 5 < 2.1 \qquad [ Equation 2 - 5 ]$$

$$0 < CT 6 / ET 6 < 1.5 \qquad [ Equation 2 - 6 ]$$

$$1 < CT 7 / ET 7 < 3 \qquad [ Equation 2 - 7 ]$$

$$1 < CT 8 / ET 8 < 5 \qquad [ Equation 2 - 8 ]$$

$$0.5 < SD / TD < 1 \qquad [ Equation 2 - 9 ]$$

When the ratio of the center thickness to the edge thickness of the second to ninth lenses 102 to 109 in Equations 2-1 to 2-8 is satisfied, the optical system 1000 may have improved chromatic aberration control characteristics.

The SD is the optical axis distance (unit: mm) from the aperture stop to the sensor-side eighteenth surface S18 of the ninth lens 109, and the TD is the optical axis distance (unit: mm) from the object-side first surface S1 of the first lens 101 to the sensor-side eighteenth surface S18 of the ninth lens 109. The aperture stop may be disposed on the circumference of the object-side surface of the third lens 103. When the optical system 1000 according to the embodiment satisfies Equation 2-9, chromatic aberration of the optical system 1000 may be improved.

$$1 < \vert F\_LG2 / F\_LG1 \vert < 10 \qquad [ Equation 2 - 10 ]$$

The F_LG1 is the focal length of the first lens group LG1, and the F_LG2 is the focal length of the second lens group LG2. When the optical system 1000 according to the embodiment satisfies Equation 2-10, chromatic aberration of the optical system 1000 may be improved. That is, as the value of Equation 2-10 approaches 1, the distortion aberration may be reduced.

$$1 < ET 9 / CT 9 < 5 \qquad [ Equation 3 ]$$

When Equation 3 satisfies the thickness CT9 of the optical axis OA of the ninth lens 109 and the edge thickness ET9 at the end of the effective region of the ninth lens 109, the optical system 1000 may affect distortion aberration reduction and may have improved optical performance.

$$1.6 < n 3 \qquad [ Equation 4 ]$$

In Equation 4, n3 means the refractive index of the third lens 103 at the d-line. When the optical system 1000 according to the embodiment satisfies Equation 4, the optical system 1000 may improve chromatic aberration characteristics.

$$1. 50 < n 1 < 1.6 \qquad [ Equation 4 - 1 ]$$

$$1.5 < n 9 < 1.6$$

In Equation 4-1, n1 is the refractive index of the first lens 101 at the d-line, and n9 is the refractive index of the ninth lens 109 at the d-line. When the optical system 1000 according to the embodiment satisfies Equation 4-1, the effect of the TTL of the optical system 1000 may be suppressed.

$$1. 60 < n 6 \qquad [ Equation 4 - 2 ]$$

$$1. 60 < n 7$$

In Equation 4-2, n6 is the refractive index of the sixth lens 106 at the d-line, and n7 is the refractive index of the seventh lens 107 at the d-line. When the optical system 1000 according to the embodiment satisfies Equation 4-2, the optical system 1000 may improve chromatic aberration characteristics.

$$0.5 < L 9 S 2 \_max \_sag to Sensor < 2 \qquad [ Equation 5 ]$$

In Equation 5, L9S2_max_sag to Sensor means the distance (unit: mm) from the maximum Sag value of the sensor-side eighteenth surface S18 of the ninth lens 109 to the image sensor 300 in the direction of the optical axis OA. For example, L9S2_max_sag to Sensor means a distance (unit: mm) from the center of the ninth lens 109 to the image sensor 300 in the direction of the optical axis OA. When the optical system 1000 according to the embodiment satisfies Equation 5, the optical system 1000 may secure a space in which the optical filter 500 may be disposed between the plurality of lenses 100 and the image sensor 300, thereby having improved assemblability. In addition, when the optical system 1000 satisfies Equation 5, the optical system 1000 may secure a distance for module manufacturing.

In the lens data for the embodiment, the position of the filter 500, in detail, the distance between the last lens and the filter 500, and the distance between the image sensor 300 and the filter 500 are set for convenience in the design of the optical system 1000, and the filter 500 may be freely disposed within a range in which the last lens and the image sensor 300 do not come into contact. Accordingly, the value of the L9S2_max_sag to Sensor in the lens data may be equal to the distance in the optical axis OA between the object-side surface of the filter 500 and the image surface of the image sensor 300 and may be smaller than the BFL of the optical system 1000, and the position of the filter 500 may move within a range that is not contact the last lens and the image sensor 300, respectively, and have good optical performance. That is, the distance between the critical point P2 and the image sensor 300 of the eighteenth surface S18 of the ninth lens 109 is the minimum, and may gradually increase toward the end of the effective region.

$$1 < BFL / L 9 S 2 \_max \_sag to Sensor < 2 \qquad [ Equation 6 ]$$

In Equation 6, BFL means the distance (unit: mm) in the optical axis OA from the center of the sensor-side eighteenth surface S18 of the ninth lens 109 closest to the image sensor 300 to the image surface of the image sensor 300. When the optical system 1000 according to the embodiment satisfies Equation 6, the optical system 1000 may improve distortion aberration characteristics and may have good optical performance in the periphery portion of the FOV. Here, the maximum Sag value may be the position of the critical point.

$$5 < \vert L 9 S 1 \_maxslope \vert < 65 \qquad [ Equation 7 ]$$

In Equation 7, L9S1_max slope means the maximum value (Degree) of the tangent angle measured on the object-side seventeenth surface S17 of the ninth lens 109. In detail, the L7S1_max slope on the seventeenth surface S17 means an angle value (Degree) of a point having the largest tangential angle with respect to a virtual line extending in a direction perpendicular to the optical axis OA. When the optical system 1000 according to the embodiment satisfies Equation 7, the optical system 1000 may control the occurrence of lens flare.

$$0.2 < L 9 S 2 Infection Point < 0.6 \qquad [ Equation 8 ]$$

In Equation 8, the L9S2 Inflection Point may mean the location of a critical point located on the sensor-side eighteenth surface S18 of the ninth lens 109. In detail, in L9S2, the inflection point may be a ratio of the distance from the optical axis OA to the critical point on the optical axis when the distance from the end of the effective region is 1. In the L9S2, the critical point may be located within 1.5 mm±0.3 mm from the optical axis OA. When the optical system 1000 according to the embodiment satisfies Equation 8, the influence on the slim rate of the optical system 1000 may be suppressed.

$$1 < CG 8 / G8\_min < 40 \qquad [ Equation 9 ]$$

In Equation 9, CG8 means the distance (unit: mm) between the eighth lens 108 and the ninth lens 109 in the optical axis OA, and G8_min means the minimum distance (unit: mm) among the distances between the eighth lens 108 and the ninth lens 109. When the optical system 1000 according to the embodiment satisfies Equation 9, the optical system 1000 may improve distortion aberration characteristics and may have good optical performance in the periphery portion of the FOV. Equation 9 may satisfy: 1<CG8/G8_min≤20 or 1<CG8/G8_min≤10.

$$0 < CG 8 / EG 8 < 0.5 \qquad [ Equation 10 ]$$

In Equation 10, CG8 means the distance (unit: mm) between the eighth lens 108 and the ninth lens 109 in the optical axis OA, and the EG8 means the optical axis distance at the end of the effective regions of the eighth lens 108 and the ninth lens 109. When the optical system 1000 according to the embodiment satisfies Equation 10, good optical performance may be obtained even at the center and periphery portions of the FOV. In addition, the optical system 1000 may reduce distortion and thus have improved optical performance.

$$0.01 < CG 1 / CG 8 < 1 \qquad [ Equation 11 ]$$

In Equation 11, CG1 means the optical axis distance (unit: mm) between the first lens 101 and the second lens 102, and the CG8 means the optical axis distance between the eighth lens 108 and the ninth lens 109. When the optical system 1000 according to the embodiment satisfies Equation 11, the optical system 1000 may improve aberration characteristics, and control the size of the optical system 1000, for example, TTL reduction.

$$3 < CA\_L9S2 / CG 8 < 20 \qquad [ Equation 11 - 1 ]$$

In Equation 11-1, CA_L9S2 is the effective diameter of the largest lens surface, and is the size of the effective diameter of the sensor-side eighteenth surface S18 of the ninth lens 109. When the optical system 1000 according to the embodiment satisfies Equation 11-1, the optical system 1000 may improve aberration characteristics and control TTL reduction.

$$0 < CT 1 / CT 8 < 2 \qquad [ Equation 12 ]$$

When Equation 12 satisfies the thickness CT1 of the first lens 101 in the optical axis OA and the thickness CT8 of the eighth lens 108 in the optical axis OA, the optical system 1000 may have improved aberration characteristics. In addition, the optical system 1000 has good optical performance at a set FOV and may control a TTL.

$$0 < CT 7 / CT 8 < 5 \qquad [ Equation 13 ]$$

When Equation 13 satisfies the thickness CT7 of the seventh lens 107 in the optical axis OA and the thickness CT8 of the eighth lens 108 in the optical axis, the optical system 1000 may alleviate the manufacturing precision of the eighth lens 108 and the ninth lens 109, and may improve optical performance of the center and periphery portions of the FOV.

$$0 < L 8 R 2 / L 9 R 1 < 5 \qquad [ Equation 14 ]$$

In Equation 14, L8R2 means the curvature radius (unit: mm) of the optical axis OA of the sixteenth surface S16 of the eighth lens 108, and L9R1 means the curvature radius (unit: mm) in the optical axis of the seventeenth surface S17 of the ninth lens 109. When the optical system 1000 according to the embodiment satisfies Equation 14, the aberration characteristics of the optical system 1000 may be improved.

$$0 < ( CG 8 - EG 8 ) / ( CG 8 ) < 2 \qquad [ Equation 15 ]$$

When Equation 15 satisfies the center distance and the edge distance between the seventh and eighth lenses 107 and 108, the optical system 1000 may reduce distortion and have improved optical performance. When the optical system 1000 according to the embodiment satisfies Equation 15, the optical performance of the center and periphery portions of the FOV may be improved.

$$1 < CA\_L1S1 / CA\_L3S1 < 1.5 \qquad [ Equation 16 ]$$

In Equation 16, CA_L1S1 means a size (unit: mm) of the effective diameter CA (clear aperture) of the first surface S1 of the first lens 101, CA_L3S1 means a size (unit: mm) of the effective diameter CA of the fifth surface S5 of the third lens 103. When the optical system 1000 according to the embodiment satisfies Equation 16, the optical system 1000 may control light incident to the first lens group LG1 and may have improved aberration control characteristics.

$$1 < CA\_L8S2 / CA\_L4S2 < 5 \qquad [ Equation 17 ]$$

In Equation 17, CA_L4S2 means a size (unit: mm) of the effective diameter CA of the eighth surface S8 of the fourth lens 104, CA_L8S2 means the size (unit: mm) of the effective diameter CA of the sixteenth surface S16 of the eighth lens 108. When the optical system 1000 according to the embodiment satisfies Equation 17, the optical system 1000 may control light incident to the second lens group LG2 and improve aberration characteristics.

$$0.5 < CA\_L3S2 / CA\_L4S1 < 1.5 \qquad [ Equation 18 ]$$

In Equation 18, CA_L3S2 means the size (unit: mm) of the effective diameter CA of the sixth surface S6 of the third lens 103, and CA_L4S1 means the size (unit: mm) of the effective diameter CA of the seventh surface S7 of the fourth lens 104. When the optical system 1000 according to the embodiment satisfies Equation 18, the optical system 1000 may improve chromatic aberration and control vignetting for optical performance.

$$1 < CA\_L5S2 / CA\_L7S2 < 1 \qquad [ Equation 19 ]$$

In Equation 19, CA_L5S2 means the size (unit: mm) of the effective diameter of the tenth surface S10 of the fifth lens 105, and CA_L7S2 means the size (unit: mm) of the effective diameter of the fourteenth surface S14 of the seventh lens 107. When the optical system 1000 according to the embodiment satisfies Equation 19, the optical system 1000 may improve chromatic aberration.

$$1 < CA\_L9S2 / CA\_L1S1 < 5 \qquad [ Equation 19 - 1 ]$$

In Equation 19-1, CA_L9S1 means the size (unit: mm) of the effective diameter of the seventeenth surface S17 of the ninth lens 109, and CA_L1S1 means the size (unit: mm) of the effective diameter of the first surface S1 of the first lens 101. When the optical system 1000 according to the embodiment satisfies Equation 19-1, the optical system 1000 may improve chromatic aberration.

$$2 < CG 3 / EG 3 < 20 \qquad [ Equation 20 ]$$

In Equation 20, CG3 is a distance between the third and fourth lenses 103 and 104 in the optical axis OA, and EG4 is an edge distance between the third and fourth lenses 103 and 104. When the optical system 1000 according to the embodiment satisfies Equation 20, the optical system 1000 may reduce chromatic aberration, improve aberration characteristics, and control vignetting for optical performance.

$$0 < CG 7 / EG 7 < 1 \qquad [ Equation 21 ]$$

In Equation 21, CG7 and EG7 mean the center distance and the edge distance between the seventh lens 107 and the eighth lens 108. When the optical system 1000 according to the embodiment satisfies Equation 21, good optical performance may be obtained even at the center and periphery portions the FOV, and distortion may be suppressed.

At least one of Equations 20 and 21 may further include at least one of Equations 21-1 to 21-6.

$$0 < CG 1 / EG 1 < 1 \qquad [ Equation 21 - 1 ]$$

satisfies: 0<CG2/EG2<1, and may be smaller than the value of Equation 21-1. [Equation 21-2]

satisfies: 0<CG4/EG4<1.2, and may be greater than the value of Equation 21-1. [Equation 21-3]

satisfies: 1<CG5/EG5<10, and may be smaller than the value of Equation 20. [Equation 21-4]

satisfies: 0<CG6/EG6<1, and may be greater than the value of Equation 21-2. [Equation 21-5]

satisfies: 0<CG8/EG8<1, and may be greater than the value of Equation 21-3. [Equation 21-6]

$$0 < G8\_max / CG 8 < 2 \qquad [ Equation 22 ]$$

In Equation 22, G8_Max means the maximum distance among the distances (unit: mm) between the eighth lens 108 and the ninth lens 109. When the optical system 1000 according to the embodiment satisfies Equation 22, optical performance may be improved in the periphery portion of the FOV, and distortion of aberration characteristics may be suppressed.

$$1 < CT 6 / CG 6 < 10 \qquad [ Equation 23 ]$$

In Equation 23, CT6 means the thickness (unit: mm) of the sixth lens 106 in the optical axis OA, and CG6 means the distance (unit: mm) between the sixth lens 106 and the seventh lens 107 in the optical axis OA. When the optical system 1000 according to the embodiment satisfies Equation 23, the optical system 1000 may reduce the size of the effective diameter of the fifth and sixth lenses and the center distance between adjacent lenses, and improve the optical performance of the periphery portion of the FOV.

$$1 < CT 7 / CG 7 < 10 \qquad [ Equation 24 ]$$

When Equation 24 satisfies the thickness CT7 of the seventh lens 107 in the optical axis OA and the distance CG7 between the seventh and eighth lenses 107 and 108, the optical system 1000 may reduce the size of the effective diameters and the distances in the sixth, seventh, and eighth lenses, and improve the optical performance of the periphery portion of the FOV.

$$0 < CT 8 / CG 8 < 1 \qquad [ Equation 25 ]$$

When Equation 25 satisfies the thickness CT8 of the eighth lens 108 in the optical axis OA and the distance CG8 between the eighth and ninth lenses 108 and 109, the optical system 1000 may reduce the size of the effective diameter of the eighth lenses and the center distance between the eighth and ninth lenses, and improve the optical performance of the periphery portion of the FOV.

$$1 < \vert L 5 R 2 / CT 5 \vert < 100 \qquad [ Equation 26 ]$$

When Equation 26 satisfies the curvature radius L5R2 of the tenth surface S10 of the fifth lens 105 and the thickness CT5 in the optical axis of the fifth lens 105, the optical system 1000 may control the refractive power of the fifth lens 105, and improve optical performance of light incident to the second lens group LG2.

$$0 < \vert L 5 R 1 / L 7 R 1 \vert < 10 \qquad [ Equation 27 ]$$

When Equation 27 satisfies the curvature radius L5R1 of the ninth surface S9 of the fifth lens 105 and the curvature radius L7R1 of the thirteenth surface S13 of the seventh lens 107, the shape and refractive power of the fifth and seventh lenses may control and the optical performance may be improved, and the optical performance of the second lens group LG2 may be improved. Equation 27 may include at least one of Equations 27-1 to 27-9 below.

$$0 < L 1 R 1 / L 1 R 2 < 1.2 \qquad [ Equation 27 - 1 ]$$

$$1 < L 2 R 2 / L 2 R 1 < 10 \qquad [ Equation 27 - 2 ]$$

$$1 < L 3 R 1 / L 3 R 2 < 5 \qquad [ Equation 27 - 3 ]$$

$$1 < L 4 R 1 / L 4 R 2 < 5 \qquad [ Equation 27 - 4 ]$$

$$1 < L 5 R 1 / L 5 R 2 < 3 \qquad [ Equation 27 - 5 ]$$

$$5 < \vert L 6 R 2 / L 6 R 1 \vert < 30 \qquad [ Equation 27 - 6 ]$$

$$1 < \vert L 7 R 1 / L 7 R 2 \vert < 5 \qquad [ Equation 27 - 7 ]$$

$$2 < L 8 R 2 / L 8 R 1 < 20 \qquad [ Equation 27 - 8 ]$$

$$1 < L 9 R 1 / L 9 R 2 < 10 \qquad [ Equation 27 - 9 ]$$

$$0 < CT\_Max / CG\_Max < 2 \qquad [ Equation 28 ]$$

In Equation 28, CT_max means the thickest thickness (unit: mm) in the optical axis OA of each of the plurality of lenses 100, and CG_max means the maximum value of the air gaps or distances (unit: mm) between the plurality of lenses 100 in the optical axis. When the optical system 1000 according to the embodiment satisfies Equation 28, the optical system 1000 has good optical performance at the set FOV and focal length, and reduces the size of the optical system 1000, for example, TTL.

$$0.5 < \sum CT / \sum CG < 3 \qquad [ Equation 29 ]$$

In Equation 29, ΣCT means the sum of thicknesses (unit: mm) in the optical axis OA of each of the plurality of lenses 100, and ΣCG means the sum of the distances (unit: mm) between two adjacent lenses in the plurality of lenses 100 in the optical axis OA. When the optical system 1000 according to the embodiment satisfies Equation 29, the optical system 1000 has good optical performance at the set FOV and focal length, and reduces the size of the optical system 1000, for example, TTL.

$$10 < \sum Index < 30 \qquad [ Equation 30 ]$$

In Equation 30, ΣIndex means the sum of the refractive indices of each d-line of the plurality of lenses 100. When the optical system 1000 according to the embodiment satisfies Equation 30, the TTL of the optical system 1000 may be controlled, and resolution may be improved. Here, the average refractive index of the first to ninth lenses 101 to 109 may be 1.5 or more.

$$10 < \sum Abbe / \sum Index < 50 \qquad [ Equation 31 ]$$

In Equation 31, ΣAbbe means the sum of Abbe numbers of each of the plurality of lenses 100. When the optical system 1000 according to the embodiment satisfies Equation 31, the optical system 1000 may have improved aberration characteristics and resolution. An average Abbe number of the first to ninth lenses 101 to 109 may be 30 or more.

$$0 < \vert Max\_distortion \vert < 5 \qquad [ Equation 32 ]$$

In Equation 32, Max_distortion means the maximum value of distortion in a region from the center (0.0 F) to the diagonal end (1.0 F) based on the optical characteristics detected by the image sensor 300. When the optical system 1000 according to the embodiment satisfies Equation 32, the optical system 1000 may improve distortion characteristics.

$$0 < EG\_Max / CT\_Max < 2 \qquad [ Equation 33 ]$$

In Equation 33, CT_max means the thickest thickness (unit: mm) among the thicknesses in the optical axis OA of each of the plurality of lenses 100, and EG_Max means the maximum edge distance between two adjacent lenses. When the optical system 1000 according to the embodiment satisfies Equation 33, the optical system 1000 has a set FOV and focal length, and may have good optical performance in the periphery portion of the FOV.

$$0.5 < CA\_L1S1 / CA\_min < 2 \qquad [ Equation 34 ]$$

In Equation 34, CA_L1S1 means the effective diameter (unit: mm) of the first surface S1 of the first lens 101, and CA_Min means the smallest effective diameter (unit: mm) of the first to eighteenth surfaces S1-S18. When the optical system 1000 according to the embodiment satisfies Equation 34, it is possible to control light incident through the first lens 101 and provide a slim optical system while maintaining optical performance.

$$1 < CA\_max / CA\_min < 5 \qquad [ Equation 35 ]$$

In Equation 35, CA_max means the largest effective diameter (unit: mm) among the object-side and sensor-side surfaces of the plurality of lenses 100, and means the largest effective diameter among the effective diameters (unit: mm) of the first to eighteenth surfaces S1-S18. When the optical system 1000 according to the embodiment satisfies Equation 35, the optical system 1000 may provide a slim and compact optical system while maintaining optical performance.

$$1 < CA\_max / CA\_Aver < 3 \qquad [ Equation 36 ]$$

In Equation 36, CA_max means the largest effective diameter (unit: mm) among the object-side and sensor-side surfaces of the plurality of lenses, and CA_Aver means the average of the effective diameters of the object-side and sensor-side surfaces of the plurality of lenses. When the optical system 1000 according to the embodiment satisfies Equation 36, a slim and compact optical system may be provided.

$$0.1 < CA\_min / CA\_Aver < 1 \qquad [ Equation 37 ]$$

In Equation 37, CA_min means the smallest effective diameter (unit: mm) among the object-side and sensor-side surfaces of the plurality of lenses. When the optical system 1000 according to the embodiment satisfies Equation 37, a slim and compact optical system may be provided.

$$0.1 < CA\_max / ( 2 \times ImgH ) < 1 \qquad [ Equation 38 ]$$

In Equation 38, CA_max means the largest effective diameter among the object-side and sensor-side surfaces of the plurality of lenses 100, and ImgH means the distance (unit: mm) from the center (0.0 F) of the image sensor 300 overlapping the optical axis OA to the diagonal end (1.0 F). That is, the ImgH means ½ of the maximum diagonal length (unit: mm) of the effective region of the image sensor 300. When the optical system 1000 according to the embodiment satisfies Equation 38, the optical system 1000 has good optical performance in the center and periphery portions of the FOV, and may provide a slim and compact optical system. Here, the ImgH may be in the range of 4 mm to 10 mm.

$$0 \text{.5} < TD / CA\_max < 1.5 \qquad [ Equation 39 ]$$

In Equation 39, TD is the maximum optical axis distance (unit: mm) from the object-side surface of the first lens group LG1 to the sensor-side surface of the second lens group LG2. For example, it is the distance from the first surface S1 of the first lens 101 to the eighteenth surface S18 of the ninth lens 109 on the optical axis OA. When the optical system 1000 according to the embodiment satisfies Equation 39, a slim and compact optical system may be provided.

$$0 < F / L 8 R 2 < 1 \qquad [ Equation 40 ]$$

In Equation 40, F means the total focal length (unit: mm) of the optical system 1000, and L8R2 means the curvature radius (unit: mm) of the sixteenth surface S16 of the eighth lens 108. When the optical system 1000 according to the embodiment satisfies Equation 40, the optical system 1000 may reduce the size of the optical system 1000, for example, reduce the TTL.

Equation 40 may further include Equation 40-1 below.

$$1 < F / F \# < 6 \qquad [ Equation 40 - 1 ]$$

The F# may mean an F number.

$$1 < F / L 1 R 1 < 10 \qquad [ Equation 41 ]$$

In Equation 41, L1R1 means the curvature radius (unit: mm) of the first surface S1 of the first lens 101, and F means the effective focal length (unit: mm). When the optical system 1000 according to the embodiment satisfies Equation 41, the size of the optical system 1000 may be reduced, for example, a TTL may be reduced.

$$0 < EPD / L 9 R 2 < 10 \qquad [ Equation 42 ]$$

In Equation 42, EPD means the entrance pupil diameter (unit: mm) of the optical system 1000, and L9R2 means the curvature radius (unit: mm) of the eighteenth surface S18 of the ninth lens 109. When the optical system 1000 according to the embodiment satisfies Equation 42, the optical system 1000 may control overall brightness and may have good optical performance in the center and periphery portions of the FOV. Equation 42 may further include Equation 42-1 below.

$$1 < EPD / F \# < 3 \qquad [ Equation 42 - 1 ]$$

$$0.5 < EPD / L 1 R 1 < 8 \qquad [ Equation 43 ]$$

Equation 42 represents the relationship between of the EPD of the optical system and the curvature radius of the first surface S1 of the first lens 101, and may control incident light.

$$0 < F 13 / F < 5 \qquad [ Equation 44 ]$$

In Equation 44, F means the total focal length (unit: mm) of the optical system 1000. Equation 44 establishes a relationship between the focal length F13 of the first lens group LG1 and the total focal length. When the optical system 1000 according to the embodiment satisfies Equation 44, the optical system 1000 may control the TTL of the optical system 1000.

$$0 < F 13 / F 3 < 5 \qquad [ Equation 44 - 1 ]$$

In Equation 44-1, F13 means the composite focal length of the 1-3 lenses, that is, the focal length (unit: mm) of the first lens group, and F3 means the focal length (unit: mm) of the third lens 103. When the optical system 1000 according to the embodiment satisfies Equation 44-1, it may have appropriate refractive power for controlling the light path incident to the first lens group and improve resolving power. Equation 44 may further include at least one of Equations 44-1 to 44-6 below.

[Equation 44-1] 0<F1/F2<5 (F1 and F2 are the focal lengths of the first and second lenses)

$$0 < F 1 / F < 4 \qquad [ Equation 44 - 2 ]$$

$$0 < F 1 / F 13 < 3 \qquad [ Equation 43 - 3 ]$$

$$F 3 < 0 , F 6 < 0 , F 7 < 0 , and F 9 < 0 \qquad [ Equation 43 - 4 ]$$

In Equation 44-4, F3, F6, F7, and F9 mean the focal lengths (unit: mm) of the third, sixth, seventh, and ninth lenses 103, 106, 107, and 109. When Equation 44-4 satisfies the above range, the resolving power may be improved by controlling the refractive power of each lens, and the optical system may be provided in a slim and compact size. Each of F3, F6, F7, and F9 may be, for example, in the range of −1 mm to −30 mm.

$$F 49 < 0 \qquad [ Equation 44 - 5 ]$$

In Equation 44-5, F49 means the composite focal length (unit: mm) of the fourth to ninth lenses. When Equation 44-5 satisfies the above range, resolving power may be improved by controlling the refractive power of the second lens group, and the optical system may be provided in a slim and compact size. In Equation 45-5, for example, F49 may be in the range of −1 mm to −50 mm.

$$0 < F 13 < 20 \qquad [ Equation 44 - 6 ]$$

In Equation 44-6, F13 means the composite focal length (unit: mm) of the first, second, and third lenses. When Equation 44-6 satisfies the above range, it is possible to control factors affecting the reduction of distortion aberration by controlling the refractive powers of the first, second and third lenses. In Equation 44-6, for example, F13 may range from 5 mm to 15 mm.

$$1 < \vert F 49 \vert / F 13 < 15 \qquad [ Equation 45 ]$$

In Equation 46, F13 means the composite focal length (unit: mm) of the first to third lenses, and F49 means the composite focal length (unit: mm) of the fourth to ninth lenses. Equation 46 establishes a relationship between the focal length F_LG1 of the first lens group LG1 and the focal length F_LG2 of the second lens group LG2. In an embodiment, the composite focal length of the first to third lenses may have a positive (+) value, and the composite focal length of the fourth to ninth lenses may have a negative (−) value. When the optical system 1000 according to the embodiment satisfies Equation 46, the optical system 1000 may improve aberration characteristics such as chromatic aberration and distortion aberration.

$$2 mm < TTL < 20 mm \qquad [ Equation 46 ]$$

In Equation 46, TTL means the distance (unit: mm) in the optical axis OA from the apex of the first surface S1 of the first lens 101 to the image surface of the image sensor 300. By setting the TTL to less than 20 mm in Equation 46, a slim and compact optical system may be provided.

$$2 mm < ImgH \qquad [ Equation 47 ]$$

Equation 47 sets the diagonal size (2*ImgH) of the image sensor 300 to 4 mm or more, thereby providing an optical system with high resolution.

$$BFL < 2.5 mm \qquad [ Equation 48 ]$$

Equation 48 makes the BFL less than 2.5 mm, so that the installation space of the filter 500 may be secured and the assembly of the components is improved through the gap between the image sensor 300 and the last lens and improve coupling reliability.

$$2 mm < F < 20 mm \qquad [ Equation 49 ]$$

In Equation 49, the total focal length F may be set to suit the optical system.

$$FOV < 120 degrees \qquad [ Equation 50 ]$$

In Equation 51, a FOV means a field of view of the optical system 1000, and an optical system of less than 120 degrees may be provided. The FOV may be greater than 70 degrees, for example, in the range of 70 degrees to 115 degrees.

$$0.5 < TTL / CA\_max < 2 \qquad [ Equation 51 ]$$

In Equation 52, CA_max means the largest effective diameter (unit: mm) among the object-side and sensor-side surfaces of the plurality of lenses, and TTL means the distance (unit: mm) in the optical axis OA from the apex of the first surface S1 of the first lens 101 to the image surface of the image sensor 300. Equation 51 sets the relationship between the total optical axis length and the maximum effective diameter of the optical system, thereby providing a slim and compact optical system.

$$0.5 < TTL / ImgH < 3 \qquad [ Equation 52 ]$$

Equation 52 may set the TTL of the optical system and the diagonal length (ImgH) from the optical axis of the image sensor 300. When the optical system 1000 according to the embodiment satisfies Equation 53, the optical system 1000 secures a BFL for the application of a relatively large-sized image sensor 300, for example, a large-sized image sensor 300 around 1 inch, and may have a smaller TTL and may have a high-definition implementation and a slim structure

$$0.01 < BFL / ImgH < 0.5 \qquad [ Equation 53 ]$$

$$2 < ImgH / BFL < 10 \qquad [ Equation 53 - 1 ]$$

Equations 53 and 53-1 may set the distance in the optical axis between the image sensor 300 and the last lens and the length in the diagonal direction from the optical axis of the image sensor 300. When the optical system 1000 according to the embodiment satisfies Equation 53 or 53-1, the optical system 1000 may secure a BFL for applying a relatively large image sensor 300, for example, a large image sensor 300 of around 1 inch, and minimize the distance between the last lens and the image sensor 300, thereby having good optical characteristics at the center and periphery portion of the FOV.

$$7 < TTL / BFL < 13 \qquad [ Equation 54 ]$$

Equation 54 may set (unit, mm) the total optical axis length (TTL) of the optical system and the optical axis distance (BFL) between the image sensor 300 and the last lens. When the optical system 1000 according to the embodiment satisfies Equation 54, the optical system 1000 secures BFL and may be provided slim and compact.

$$0.5 < F / TTL < 1.5 \qquad [ Equation 55 ]$$

Equation 55 may set the total focal length F and the total optical axis length (TTL) of the optical system 1000. Accordingly, a slim and compact optical system may be provided.

0<F#/TTL<0.5 [Equation 55-1]

Equation 55-1 may set the F number F# and the total optical axis length (TTL) of the optical system 1000. Accordingly, a slim and compact optical system may be provided.

$$3 < F / BFL < 10 \qquad [ Equation 56 ]$$

Equation 57 may set (unit, mm) the total focal length F of the optical system 1000 and the optical axis distance (BFL) between the image sensor 300 and the last lens. When the optical system 1000 according to the embodiment satisfies Equation 56, the optical system 1000 may have a set FOV, may have an appropriate focal length, and may provide a slim and compact optical system. In addition, the optical system 1000 may minimize the distance between the last lens and the image sensor 300, so that it may have good optical characteristics in the periphery portion of the FOV.

$$0.1 < F / ImgH < 3 \qquad [ Equation 57 ]$$

Equation 57 may set the total focal length F (unit: mm) of the optical system 1000 and the diagonal length (ImgH) of the optical axis of the image sensor 300. The optical system 1000 may have improved aberration characteristics by applying a relatively large image sensor 300, for example, a large image sensor 300 of around 1 inch.

$$1 < F / EPD < 5 \qquad [ Equation 58 ]$$

Equation 58 may set the total focal length F (unit: mm) of the optical system 1000 and the entrance pupil diameter. Accordingly, the overall brightness of the optical system may be controlled.

$$0 < n 3 / n 4 < 1.5 \qquad [ Equation 59 ]$$

When the refractive indices n3 and n4 of the third and fourth lenses 103 and 104 of Equation 59 satisfy the above range, the optical system may improve resolution. In addition, the refractive indices n1 and n2 of the first and second lenses 101 and 102 at the d-line may satisfy: 0<n1/n2<1.5.

$$[ Equation 60 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + …$$

In Equation 60, Z is Sag and may mean a distance in the optical axis direction from an arbitrary position on the aspherical surface to the apex of the aspheric surface. The Y may mean a distance in a direction perpendicular to the optical axis from an arbitrary position on the aspheric surface to the optical axis. The c may mean the curvature of the lens, and K may mean the conic constant. Also, A, B, C, D, E, and F may mean aspheric constants.

The optical system 1000 according to the embodiment may satisfy at least one or two or more of Equations 1 to 59. In this case, the optical system 1000 may have improved optical characteristics. In detail, when the optical system 1000 satisfies at least one or two or more of Equations 1 to 59, the optical system 1000 has improved resolution and may improve aberration and distortion characteristics. In addition, the optical system 1000 can secure a BFL for applying the large-size image sensor 300, and may minimize the distance between the last lens and the image sensor 300, and thus have good optical performance in the center and periphery portions of the FOV. In addition, when the optical system 1000 satisfies at least one of Equations 1 to 59, it may include a relatively large image sensor 300, have a relatively small TTL value, and may provide a slimmer and more compact optical system and a camera module having the same.

In the optical system 1000 according to the embodiment, the distance between the plurality of lenses 100 may have a value set according to the region.

Table 1 relates to the items of the above-mentioned equations in the optical system 1000 according to the embodiment, and relates the TTL, BFL, total focal length F value, ImgH, focal lengths F1, F2, F3, F4, F5, F6, F7, F8, and F9, composite focal lengths, and edge thickness ET of each of the first to ninth lenses. Here, the edge thickness of the lens means the thickness in the optical axis direction Z at the end of the effective region of the lens, and the unit is mm.

TABLE 1

| Items | Values | Items | Values |
|---|---|---|---|
| F | 7.847 | ET1 | 0.2501 |
| F1 | 16.087 | ET2 | 0.2500 |
| F2 | 10.536 | ET3 | 0.3471 |
| F3 | −18.789 | ET4 | 0.2500 |
| F4 | 39.935 | ET5 | 0.2500 |
| F5 | 189.424 | ET6 | 0.3554 |
| F6 | −16.150 | ET7 | 0.2907 |
| F7 | −14.044 | ET8 | 0.3044 |
| F8 | 5.400 | ET9 | 0.4798 |
| F9 | −6.245 | EG1 | 0.415 |
| F_LG1 | 9.129 | EG2 | 0.181 |
| F_LG2 | −22.677 | EG3 | 0.050 |
| EPD | 3.946 | EG4 | 0.318 |
| BFL | 0.881 | EG5 | 0.100 |
| TD | 7.919 | EG6 | 0.215 |
| ImgH | 8.004 | EG7 | 0.095 |
| TTL | 8.800 | EG8 | 1.081 |
| F-number | 1.988 | ΣCT | 3.829 |
| FOV | 90 | ΣCG | 1.947 |

Table 2 relates to the result values of Equations 1 to 59 described above in the optical system 1000 of FIG. 1. Referring to Table 2, it may be seen that the optical system 1000 satisfies at least one, two or more, or three or more of Equations 1 to 59. In detail, it may be seen that the optical system 1000 according to the embodiment satisfies all of Equations 1 to 59. Accordingly, the optical system 1000 may improve optical performance and optical characteristics at the center and periphery portions the FOV.

TABLE 2

| | |
|---|---|
| Equations | Embodiment |

| | | |
|---|---|---|
| 1 | 0 < CT1/CT2 < 2 | 0.882 |
| 2 | 0.5 < CT3/ET3 < 2 | 0.634 |
| 3 | 1 < ET9/CT9 < 5 | 1.200 |
| 4 | 1.6 < n3 | 1.686 |
| 5 | 0.5 < L9S2_max_sag to Sensor < 2.5 | 0.738 |
| 6 | 0.5 < BFL/L9S2_max_sag to Sensor < 2 | 1.194 |
| 7 | 5 < \|L9S2_max slope\| < 65 | 31.000 |
| 8 | 1 < L9S2 Inflection Point < 2 | 1.500 |
| 9 | 1 < CG8/G8_min < 10 | 1.525 |
| 10 | 1 < CG8/EG8 < 10 | 1.517 |
| 11 | 0.01 < CG1/CG8 < 1 | 0.139 |
| 12 | 0 < CT1/CT8 < 2 | 0.939 |
| 13 | 0 < CT7/CT8 < 5 | 0.594 |
| 14 | 0 < L8R2/L9R1 < 5 | 1.845 |
| 15 | 0 < (CG8 − EG8)/(CG8) < 2 | 0.341 |
| 16 | 1 < CA_L1S1/CA_L3S1 < 1.5 | 1.152 |
| 17 | 1 < CA_L8S2/CA_L4S2 < 5 | 2.261 |
| 18 | 0.5 < CA_L3S2/CA_L4S1 < 1.5 | 1.000 |
| 19 | 0.1 < CA_L5S2/CA_L7S2 < 1 | 0.711 |
| 20 | 2 < CG3/EG3 < 20 | 11.225 |
| 21 | 0 < CG7/EG7 < 1 | 0.648 |
| 22 | 0 < G8_max/CG8 < 2 | 1.001 |
| 23 | 1 < CT6/CG6 < 10 | 2.913 |
| 24 | 1 < CT7/CG7 < 10 | 5.686 |
| 25 | 0 < CT8/CG8 < 1 | 0.359 |
| 26 | 1 < \|L5R2/CT5\| < 100 | 29.521 |
| 27 | 0 < \|L5R1/L7R1\| < 10 | 0.860 |
| 28 | 0 < CT_Max/CG_Max < 2 | 0.382 |
| 29 | 0.5 < ΣCT/ΣCG < 3 | 1.966 |
| 30 | 10 < ΣIndex < 30 | 14.341 |
| 31 | 10 < ΣAbbe/ΣIndex < 50 | 23.683 |
| 32 | 0 < \|Max_distoriton\| < 5 | 2.000 |
| 33 | 0 < EG_Max/CT_Max < 2 | 1.724 |
| 34 | 0.5 < CA_L1S1/CA_min < 2 | 1.252 |
| 35 | 1 < CA_max/CA_min < 5 | 2.116 |
| 36 | 1 < CA_max/CA_AVR < 3 | 2.116 |
| 37 | 0.1 < CA_min/CA_AVR < 1 | 7.499 |
| 38 | 0.1 < CA_max/(2*ImgH) < 1 | 0.762 |
| 39 | 0.5 < TD/CA_max < 1.5 | 0.649 |
| 40 | 0 < F/L8R2 < 10 | 0.398 |
| 41 | 1 < F/L1R1 < 10 | 2.656 |
| 42 | 0 < EPD/L9R2 < 10 | 1.567 |
| 43 | 0.5 < EPD/L1R1 < 8 | 1.336 |
| 44 | 0 < F13/F < 5 | 1.163 |
| 45 | 1 < \| F49 \|/F13 < 15 | 2.484 |
| 46 | 2 < TTL < 20 | 8.800 |
| 47 | 2 < ImgH | 8.004 |
| 48 | BFL < 2.5 | 0.881 |
| 49 | 2 < F < 20 | 7.847 |
| 50 | FOV < 120 | 90.000 |
| 51 | 0.5 < TTL/CA_max < 2 | 0.721 |
| 52 | 0.5 < TTL/ImgH < 3 | 1.099 |
| 53 | 0.01 < BFL/ImgH < 0.5 | 0.110 |
| 54 | 4 < TTL/BFL < 10 | 9.989 |
| 55 | 0.5 < F/TTL < 1.5 | 0.892 |
| 56 | 3 < F/BFL < 10 | 8.907 |
| 57 | 0 < F/ImgH < 3 | 0.980 |
| 58 | 1 < F/EPD < 5 | 1.988 |
| 59 | 0 < n3/n4 < 1.5 | 1.093 |

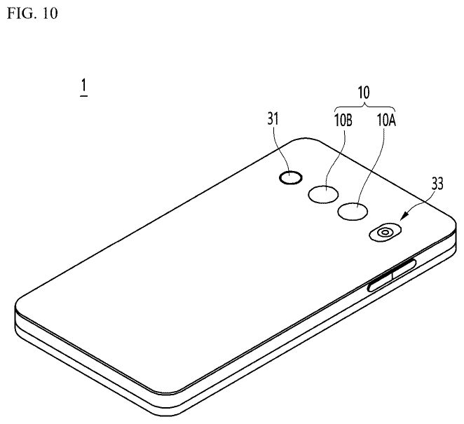

FIG. 10 is a diagram illustrating that a camera module according to an embodiment is applied to a mobile terminal. Referring to FIG. 10, the mobile terminal 1 may include a camera module 10 provided on the rear side. The camera module 10 may include an image capturing function. In addition, the camera module 10 may include at least one of an auto focus function, a zoom function, and an OIS function. The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy. In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1.-19. (canceled)

20. An optical system comprising:
first to ninth lenses disposed along the optical axis in a direction from an object side to a sensor side,
wherein the first lens and the third lens have different refractive powers on the optical axis,
wherein the first lens to the third lens have a meniscus shape that is convex toward the object side on the optical axis,
wherein an object-side surface of each of the eighth lens and the ninth lens has a convex shape on the optical axis,
wherein refractive index n6 of the sixth lenses at a d-line satisfy: 1.6<n6, and
wherein the following Equations satisfies:
$$0.5 < \sum CT / \sum CG < 3$$
$$0 < CT\_Max / CG\_Max < 2$$
(ΣCT is a sum of optical axis distances between the first to ninth lenses, CT_Max is a maximum of center thicknesses of each lens, and CG_Max is a maximum of the optical axis distances).

21. The optical system of claim 20, wherein the object-side surface of the eighth lens has a first critical point,
wherein a sensor-side surface of the ninth lens has a second critical point, and
wherein the second critical point is disposed further outside the optical axis than the first critical point with respect to the optical axis.

22. The optical system of claim 21, wherein the first critical point is disposed in a range of 32% to 52% of a distance from the optical axis of the object-side surface of the eighth lens to an end of an effective region, and the second critical point is disposed in a range of 14% to 34% of a distance from the optical axis of a sensor-side surface of the ninth lens to an end of an effective region.

23. The optical system of claim 20, wherein a maximum angle of a tangent passing through a sensor-side surface of the eighth lens is greater than a maximum angle of a tangent passing through a sensor-side surface of the ninth lens.

24. The optical system of claim 20, wherein each of the eighth lens and the ninth lens has a meniscus shape that is convex toward the object side on the optical axis.

25. The optical system of claim 20, wherein an optical axis distance CG8 between the eighth lens and the ninth lens and a minimum distance G8_Min between the eighth lens and the ninth lens satisfy the following Equation: 1<CG8/G8_min<10.

26. The optical system of claim 20, wherein a curvature radius L8R2 of a sensor-side surface of the eighth lens and a curvature radius L9R1 of the object-side surface of the ninth lens satisfy the following Equation: 0<L8R2/L9R1<5.

27. The optical system of claim 20, wherein a sensor-side surface of the third lens has a concave shape on the optical axis,
wherein an object-side surface of the fourth lens has a concave shape on the optical axis, and
wherein a center distance CG3 and an edge distance EG3 between the third and fourth lenses satisfy the following Equation: 2<CG3/EG3<20.

28. The optical system of claim 20, wherein the focal lengths F3, F6, F7, and F9 of the third, sixth, seventh, and ninth lenses respectively satisfy: F3<0, F6<0, F7<0, and F9<0,
wherein a composite focal length F13 of the first to third lenses satisfies: F13>0, and
wherein a composite focal length F49 of the fourth lens and the ninth lens satisfies: F49<0.

29. The optical system of claim 20, wherein refractive indices n3 and n5 of the third and fifth lenses at a d-line satisfy: 1.6<n3 and 1.6<n5.

30. An optical system comprising:
a first lens group having three or less lenses on an object side; and
a second lens group having a plurality of lenses on a sensor side of the first lens group,
wherein the first lens group has a positive (+) refractive power on the optical axis,
wherein the second lens group has a negative (−) refractive power on the optical axis,
wherein a number of lenses in the second lens group is greater than a number of lenses in the first lens group,
wherein at least one of lens surfaces facing a region between the first lens group and the second lens group has a minimum effective diameter,
wherein a sensor-side surface closest to the image sensor among lens surfaces of the second lens group has a maximum effective diameter,
wherein each of the lenses of the first lens group has a meniscus shape that is convex toward the object side on the optical axis, and
wherein the following Equations satisfy:
$$0.5 < TTL / ImgH < 3$$
$$0.01 < BFL / ImgH < 0.5$$
(TTL is a distance from an apex of an object-side surface of the first lens group to an image surface of the image sensor, ImgH is ½ of a maximum diagonal length of the image sensor, and BFL is an optical axis distance from the image sensor to a sensor-side surface closest to the image sensor).

31. The optical system of claim 30, when a focal length of each of the first and second lens groups is expressed as an absolute value, a focal length of the first lens group is smaller than a focal length of the second lens group.

32. The optical system of claim 30, wherein the first lens group includes first to third lenses aligned in the optical axis toward the sensor from the object side,
wherein the second lens group includes fourth to ninth lenses from the first lens group toward the sensor, and
wherein the following Equations satisfy:
$$0.5 < CA\_L 1 S 1 / CA\_min < 2$$
$$1 < CA\_max / CA\_min < 5$$
(CA_L1S1 is an effective diameter of an object-side surface of the first lens, and CA_Min is a minimum of effective diameters of object-side and sensor-side surfaces of the first to ninth lenses, and CA_Max means a maximum of the effective diameters of the object-side and sensor-side surfaces of the first to ninth lenses.).

33. The optical system of claim 32, wherein both the object-side surface and the sensor-side surface of the eighth lens have a critical point, and
wherein both the object-side surface and the sensor-side surface of the ninth lens have a critical point.

34. The optical system of claim 33, wherein a maximum of distances between the eighth and ninth lenses is a maximum of distances between the first to ninth lenses, and
wherein a maximum thickness of the ninth lens is a maximum among thicknesses from the optical axis to an end of the effective region of the first to ninth lenses.

35. The optical system of claim 33, wherein a center thickness of each lens and a center distance between adjacent lenses satisfy the following Equation:
$$0.5 < \sum CT / \sum CG < 3$$
(ΣCT is a sum of thicknesses of the first to ninth lenses in the optical axis, and ΣCG is a sum of distances between the first to ninth lenses in the optical axis.).

36. The optical system of claim 30, wherein the following Equation satisfies:
$$0.1 < CA\_max / ( 2 ⋆ ImgH ) < 1$$
(ΣCA_max means a largest effective diameter among object-side and sensor-side surfaces of each lens)

37. The optical system of claim 32, wherein a composite focal length F13 of the first lens group, an effective focal length F and a composite focal length F49 of the second lens group satisfy the following Equations:
$$0 < F 13 / F < 5$$
$$1 < \vert F 49 \vert / F 13 < 15.$$

38. A camera module comprising:
an image sensor; and
a filter disposed between the image sensor and a last lens of an optical system,
wherein the optical system includes an optical system according to claim 20, and
wherein the following Equations satisfy:
$$1 \leq F / EPD < 5$$
$$FOV < 120 degrees$$
(F is a total focal length of the optical system, EPD is an entrance pupil diameter of the optical system, and FOV is a field of view.).

39. A camera module comprising:
an image sensor; and
a filter disposed between the image sensor and a last lens of an optical system,
wherein the optical system includes an optical system according to claim 30, and
wherein the following Equations satisfy:
$$1 \leq F / EPD < 5$$
$$FOV < 120 degrees$$
(F is a total focal length of the optical system, EPD is an entrance pupil diameter of the optical system, and FOV is a field of view.).
